(19) United States
(12) Patent Application Publication
(10) Pub. No.: US 2009/0179978 A1
(43) Pub. Date: Jul. 16, 2009

(54) PRINTHEAD WITH MATCHED RESONANT DAMPING STRUCTURE

(75) Inventors: Brian Robert Brown, Balmain (AU); Norman Micheal Berry, Balmain (AU); Michael John Hudson, Balmain (AU); Akira Nakazawa, Balmain (AU); Kia Silverbrook, Balmain (AU); Gary Raymond Jackson, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/014,768

(22) Filed: Jan. 16, 2008

(51) Int. Cl. B41J 2/17

(52) U.S. Cl. 347/94

(57) ABSTRACT

A printhead that has at least one printhead integrated circuit (IC) with an array of nozzles for ejecting ink and a support structure for supporting the printhead IC. The support structure has an ink conduit for supplying the array of nozzles with ink. The conduit has a set of resonant frequencies at which ink in the conduit generates a standing wave in response to certain operating modes of the array of nozzle. A fluidic damper is incorporated into printhead, the damper having a selected resonant frequency that damps the standing waves associated with each of the set of resonant frequencies such that they have an amplitude less than a maximum threshold.

### FIELD OF THE INVENTION

The present invention relates to the field of inkjet printing and in particular, inkjet printers with pagewidth printheads.

### CO-PENDING APPLICATIONS

The following applications have been filed by the Applicant simultaneously with the present application:

| | | | | | |
|---|---|---|---|---|---|
| RRE012US | RRE014US | RRE015US | RRE016US | RRE017US | RRE018US |
| RRE019US | RRE020US | RRE021US | RRE022US | RRE023US | RRE024US |
| RRE025US | RRE026US | RRE027US | RRE028US | RRE029US | RRE030US |
| RRE031US | RRE032US | RRE033US | RRE034US | RRE035US | RRE036US |
| RRE037US | RRE038US | RRE039US | RRE040US | RRE041US | RRE042US |
| RRE043US | RRE044US | RRE045US | RRE046US | | |

The disclosures of these co-pending applications are incorporated herein by reference. The above applications have been identified by their filing docket number, which will be substituted with the corresponding application number, once assigned.

### CROSS REFERENCES

The following patents or patent applications filed by the applicant or assignee of the present invention are hereby incorporated by cross-reference.

| | | | | | | |
|---|---|---|---|---|---|---|
| 6276850 | 6520631 | 6158907 | 6539180 | 6270177 | 6405055 | 6628430 |
| 6835135 | 6626529 | 6981769 | 7125338 | 7125337 | 7136186 | 7286260 |
| 7145689 | 7130075 | 7081974 | 7177055 | 7209257 | 6443555 | 7161715 |
| 7154632 | 7158258 | 7148993 | 7075684 | 10/943905 | 10/943906 | 10/943904 |
| 10/943903 | 10/943902 | 6966659 | 6988841 | 7077748 | 7255646 | 7070270 |
| 7014307 | 7158809 | 7217048 | 11/225172 | 11/255942 | 11/329039 | 11/329040 |
| 7271829 | 11/442189 | 11/474280 | 11/483061 | 11/503078 | 11/520735 | 11/505858 |
| 11/525850 | 11/583870 | 11/592983 | 11/592208 | 11/601828 | 11/635482 | 11/635526 |
| 10/466440 | 7215441 | 11/650545 | 11/653241 | 11/653240 | 7056040 | 6942334 |
| 11/706300 | 11/740265 | 11/737720 | 11/739056 | 11/740204 | 11/740223 | 11/753557 |
| 11/750285 | 11758648 | 11/778559 | 11834634 | 11/838878 | 11845669 | 6799853 |
| 7237896 | 6749301 | 10/451722 | 7137678 | 7252379 | 7144107 | 10/503900 |
| 10/503898 | 10/503897 | 7220068 | 7270410 | 7241005 | 7108437 | 7140792 |
| 10/503922 | 7224274 | 10/503917 | 10/503918 | 10/503925 | 10/503927 | 10/503928 |
| 10/503929 | 10/503885 | 7195325 | 7229164 | 7150523 | 10/503889 | 7154580 |
| 6906778 | 7167158 | 7128269 | 6688528 | 6986613 | 6641315 | 7278702 |
| 10/503891 | 7150524 | 7155395 | 6915140 | 6999206 | 6795651 | 6883910 |
| 7118481 | 7136198 | 7092130 | 6786661 | 6808325 | 10/920368 | 10/920284 |
| 7219990 | 10/920283 | 6750901 | 6476863 | 6788336 | 6322181 | 6597817 |
| 6227648 | 6727948 | 6690419 | 10/470947 | 6619654 | 6969145 | 6679582 |
| 10/470942 | 6568670 | 6866373 | 7280247 | 7008044 | 6742871 | 6966628 |
| 6644781 | 6969143 | 6767076 | 6834933 | 6692113 | 6913344 | 6727951 |
| 7128395 | 7036911 | 7032995 | 6969151 | 6955424 | 6969162 | 10/919249 |
| 6942315 | 11/006577 | 7234797 | 6986563 | 7295211 | 11/045442 | 7286162 |
| 7283159 | 7077330 | 6196541 | 11/149389 | 11/185725 | 7226144 | 11/202344 |
| 7267428 | 11/248423 | 11/248422 | 7093929 | 11/282769 | 11/330060 | 11/442111 |
| 7290862 | 11/499806 | 11/499710 | 6195150 | 11749156 | 11782588 | 11/854435 |
| 11/853817 | 11/935958 | 11924608 | 6362868 | 11970993 | 6831681 | 6431669 |
| 6362869 | 6472052 | 6356715 | 6894694 | 6636216 | 6366693 | 6329990 |
| 6459495 | 6137500 | 6690416 | 7050143 | 6398328 | 7110024 | 6431704 |
| 6879341 | 6415054 | 6665454 | 6542645 | 6486886 | 6381361 | 6317192 |
| 6850274 | 09/113054 | 6646757 | 6624848 | 6357135 | 6271931 | 6353772 |
| 6106147 | 6665008 | 6304291 | 6305770 | 6289262 | 6315200 | 6217165 |
| 6496654 | 6859225 | 6924835 | 6647369 | 6943830 | 09/693317 | 7021745 |
| 6712453 | 6460971 | 6428147 | 6416170 | 6402300 | 6464340 | 6612687 |
| 6412912 | 6447099 | 6837567 | 6505913 | 7128845 | 6733684 | 7249108 |
| 6566858 | 6331946 | 6246970 | 6442525 | 09/517384 | 09/505951 | 6374354 |
| 7246098 | 6816968 | 6757832 | 6334190 | 6745331 | 7249109 | 10/203559 |
| 7197642 | 7093139 | 10/636263 | 10/636283 | 10/866608 | 7210038 | 10/902883 |
| 10/940653 | 10/942858 | 11/706329 | 11/757385 | 11/758642 | 7119836 | 7283162 |
| 7286169 | 10/636285 | 7170652 | 6967750 | 6995876 | 7099051 | 7172191 |
| 7243916 | 7222845 | 11/239232 | 7285227 | 7063940 | 11/107942 | 7193734 |
| 7086724 | 7090337 | 7278723 | 7140717 | 11/190902 | 11/209711 | 7256824 |
| 7140726 | 7156512 | 7186499 | 11/478585 | 11/525862 | 11/540574 | 11/583875 |
| 11/592181 | 6750944 | 11/599336 | 7291447 | 11744183 | 11/758646 | 11/778561 |
| 11/839532 | 11/838874 | 11/853021 | 11/869710 | 11/868531 | 11927403 | 11951960 |
| 10/636225 | 6985207 | 6773874 | 6650836 | 10/666495 | 10/636224 | 7250975 |
| 7295343 | 6880929 | 7236188 | 7236187 | 7155394 | 10/636219 | 10/636223 |
| 7055927 | 6986562 | 7052103 | 7312845 | 10/656281 | 10/656791 | 10/666124 |
| 10/683217 | 7289142 | 7095533 | 6914686 | 6896252 | 6820871 | 6834851 |
| 6848686 | 6830246 | 6851671 | 10/729098 | 7092011 | 7187404 | 10/729159 |
| 10/753458 | 6878299 | 6929348 | 6921154 | 10/780625 | 10/804042 | 6913346 |
| 10/831238 | 10/831237 | 10/831239 | 10/831240 | 10/831241 | 10/831234 | 10/831233 |
| 7246897 | 7077515 | 10/831235 | 10/853336 | 10/853117 | 10/853659 | 10/853681 |
| 6913875 | 7021758 | 7033017 | 7161709 | 7099033 | 7147294 | 7156494 |
| 11/012024 | 11/011925 | 7032998 | 7044585 | 7296867 | 6994424 | 11/006787 |
| 7258435 | 7097263 | 7001012 | 7004568 | 7040738 | 7188933 | 7027080 |
| 7025446 | 6991321 | 7131715 | 7261392 | 7207647 | 7182435 | 7097285 |
| 11/228410 | 7097284 | 7083264 | 7147304 | 7232203 | 7156498 | 7201471 |
| 11/501772 | 11/503084 | 11/513073 | 7210764 | 11/635524 | 11/706379 | 11/730386 |
| 11/730784 | 11/753568 | 11/782591 | 11/859783 | 6710457 | 6775906 | 6507099 |
| 7221043 | 7107674 | 7154172 | 11/442400 | 7247941 | 11/736540 | 7307354 |
| 11/940304 | 6530339 | 6631897 | 6851667 | 6830243 | 6860479 | 6997452 |
| 7000913 | 7204482 | 11/212759 | 11/281679 | 11/730409 | 6238044 | 6425661 |
| 11/003786 | 7258417 | 7293853 | 11/003334 | 7270395 | 11/003404 | 11/003419 |
| 11/003700 | 7255419 | 7284819 | 7229148 | 7258416 | 7273263 | 7270393 |
| 6984017 | 11/003699 | 11/071473 | 7156497 | 11/601670 | 11748482 | 11/778563 |
| 11/779851 | 11/778574 | 11/853816 | 11/853814 | 11/853786 | 11/872037 | 11/856694 |
| 11965703 | 11971170 | 11/003463 | 11/003701 | 11/003683 | 11/003614 | 7284820 |
| 11/003684 | 7246875 | 11/003617 | 11/764760 | 11853777 | 11955354 | 11/293800 |
| 11/293802 | 11/293801 | 11/293808 | 11/293809 | 11/482975 | 11/482970 | 11/482968 |
| 11/482972 | 11/482971 | 11/482969 | 6431777 | 6334664 | 6447113 | 7239407 |
| 6398359 | 6652089 | 6652090 | 7057759 | 6631986 | 7187470 | 7280235 |
| 11/501775 | 11744210 | 11/859784 | 6471331 | 6676250 | 6347864 | 6439704 |
| 6425700 | 6588952 | 6626515 | 6722758 | 6871937 | 11/060803 | 11/097266 |
| 11/097267 | 11/685084 | 11/685086 | 11/685090 | 11/740925 | 11/763444 | 11/763443 |
| 11946840 | 11961712 | 7249942 | 7206654 | 7162324 | 7162325 | 7231275 |
| 7146236 | 7278847 | 10/753499 | 6997698 | 7220112 | 7231276 | 10/753440 |
| 7220115 | 7195475 | 7144242 | 7306323 | 7306319 | 11/525858 | 11/545501 |
| 11/599335 | 11/706380 | 11736545 | 11/736554 | 11/739047 | 11749159 | 11/739073 |
| 11/775160 | 11/853755 | 11/940291 | 11934071 | 11951913 | 6786420 | 6827282 |
| 6948661 | 7073713 | 10/983060 | 7093762 | 7083108 | 7222799 | 7201319 |
| 11/442103 | 11/739071 | 11/518238 | 11/518280 | 11/518244 | 11/518243 | 11/518242 |
| 7032899 | 6854724 | 11/084237 | 11/084240 | 11/084238 | 11/357296 | 11/357298 |
| 11/357297 | 6350023 | 6318849 | 6592207 | 6439699 | 6312114 | 11/246676 |
| 11/246677 | 11/246678 | 11/246679 | 11/246680 | 11/246681 | 11/246714 | 11/246713 |
| 11/246689 | 11/246671 | 11/246670 | 11/246669 | 11/246704 | 11/246710 | 11/246688 |
| 11/246716 | 11/246715 | 11/246707 | 11/246706 | 11/246705 | 11/246708 | 11/246693 |
| 11/246692 | 11/246696 | 11/246695 | 11/246694 | 11/482958 | 11/482955 | 11/482962 |
| 11/482963 | 11/482956 | 11/482954 | 11/482974 | 11/482957 | 11/482987 | 11/482959 |
| 11/482960 | 11/482961 | 11/482964 | 11/482965 | 11/482976 | 11/482973 | 11/495815 |
| 11/495816 | 11/495817 | 60992635 | 60992637 | 60992641 | 10/803074 | 10/803073 |
| 7040823 | 10/803076 | 10/803077 | 10/803078 | 10/803079 | 10/922971 | 10/922970 |
| 10/922836 | 10/922842 | 10/922848 | 10/922843 | 7125185 | 7229226 | 11/513386 |
| 11/753559 | 10/815621 | 7243835 | 10/815630 | 10/815637 | 10/815638 | 7251050 |
| 10/815642 | 7097094 | 7137549 | 10/815618 | 7156292 | 11738974 | 10/815635 |
| 10/815647 | 10/815634 | 7137566 | 7131596 | 7128265 | 7207485 | 7197374 |
| 7175089 | 10/815617 | 10/815620 | 7178719 | 10/815613 | 7207483 | 7296737 |
| 7270266 | 10/815614 | 11/446240 | 11/488162 | 11/488163 | 11/488164 | 11/488167 |
| 11/488168 | 11/488165 | 11/488166 | 7267273 | 11/834628 | 11/839497 | 11/944449 |
| 10/815636 | 7128270 | 11/041650 | 11/041651 | 11/041652 | 11/041649 | 11/041610 |
| 11863253 | 11863255 | 11/863257 | 11863258 | 11863262 | 11/041609 | 11/041626 |
| 11/041627 | 11/041624 | 11/041625 | 11863268 | 11863269 | 11863270 | 11863271 |
| 11863273 | 76584733 | 11/041556 | 11/041580 | 11/041723 | 11/041698 | 11/041648 |
| 11863263 | 11863264 | 11863265 | 11863266 | 11863267 | 10/815609 | 7150398 |
| 7159777 | 10/815610 | 7188769 | 7097106 | 7070110 | 7243849 | 11/442381 |
| 11/480957 | 11/764694 | 11957470 | 6227652 | 6213588 | 6213589 | 6231163 |
| 6247795 | 6394581 | 6244691 | 6257704 | 6416168 | 6220694 | 6257705 |
| 6247794 | 6234610 | 6247793 | 6264306 | 6241342 | 6247792 | 6264307 |
| 6254220 | 6234611 | 6302528 | 6283582 | 6239821 | 6338547 | 6247796 |
| 6557977 | 6390603 | 6362843 | 6293653 | 6312107 | 6227653 | 6234609 |
| 6238040 | 6188415 | 6227654 | 6209989 | 6247791 | 6336710 | 6217153 |
| 6416167 | 6243113 | 6283581 | 6247790 | 6260953 | 6267469 | 6588882 |
| 6742873 | 6918655 | 6547371 | 6938989 | 6598964 | 6923526 | 6273544 |
| 6309048 | 6420196 | 6443558 | 6439689 | 6378989 | 6848181 | 6634735 |
| 6299289 | 6299290 | 6425654 | 6902255 | 6623101 | 6406129 | 6505916 |
| 6457809 | 6550895 | 6457812 | 7152962 | 6428133 | 7216956 | 7080895 |
| 11/144844 | 7182437 | 11/599341 | 11/635533 | 11/607976 | 11/607975 | 11/607999 |
| 11/607980 | 11/607979 | 11/607978 | 11/735961 | 11/685074 | 11/696126 | 11/696144 |
| 11/696650 | 11/763446 | 6224780 | 6235212 | 6280643 | 6284147 | 6214244 |
| 6071750 | 6267905 | 6251298 | 6258285 | 6225138 | 6241904 | 6299786 |
| 6866789 | 6231773 | 6190931 | 6248249 | 6290862 | 6241906 | 6565762 |
| 6241905 | 6451216 | 6231772 | 6274056 | 6290861 | 6248248 | 6306671 |
| 6331258 | 6110754 | 6294101 | 6416679 | 6264849 | 6254793 | 6245246 |
| 6855264 | 6235211 | 6491833 | 6264850 | 6258284 | 6312615 | 6228668 |
| 6180427 | 6171875 | 6267904 | 6245247 | 6315914 | 7169316 | 6526658 |
| 7210767 | 11/056146 | 11/635523 | 6665094 | 6450605 | 6512596 | 6654144 |
| 7125090 | 6687022 | 7072076 | 7092125 | 7215443 | 7136195 | 7077494 |
| 6877834 | 6969139 | 10/636227 | 7283280 | 6912067 | 7277205 | 7154637 |
| 10/636230 | 7070251 | 6851782 | 10/636211 | 10/636247 | 6843545 | 7079286 |
| 7064867 | 7065247 | 7027177 | 7218415 | 7064873 | 6954276 | 7061644 |
| 7092127 | 7059695 | 10/990382 | 7177052 | 7270394 | 11/124231 | 7188921 |
| 7187469 | 7196820 | 11/281445 | 7283281 | 7251051 | 7245399 | 11/524911 |
| 11/640267 | 11/706297 | 11/730387 | 11/737142 | 11/764729 | 11/834637 | 11/853019 |
| 11/863239 | 11/305274 | 11/305273 | 11/305275 | 11/305152 | 11/305158 | 11/305008 |
| 6231148 | 6293658 | 6614560 | 6238033 | 6312070 | 6238111 | 6378970 |
| 6196739 | 6270182 | 6152619 | 7006143 | 6876394 | 6738096 | 6970186 |
| 6287028 | 6412993 | 11/033145 | 11/102845 | 11/102861 | 11/248421 | 11/672878 |
| 7204941 | 7282164 | 10/815628 | 11845672 | 7278727 | 10/913373 | 10/913374 |
| 10/913372 | 7138391 | 7153956 | 10/913380 | 10/913379 | 10/913376 | 7122076 |
| 7148345 | 11/172816 | 11/172815 | 11/172814 | 11/482990 | 11/482986 | 11/482985 |
| 11/454899 | 11/583942 | 11/592990 | 11849360 | 11/831961 | 11/831962 | 11/831963 |
| 60951700 | 11/832629 | 11/832637 | 60971535 | 10/407212 | 7252366 | 10/683064 |
| 10/683041 | 7275811 | 10/884889 | 10/922890 | 10/922875 | 10/922885 | 10/922889 |
| 10/922884 | 10/922879 | 10/922887 | 10/922888 | 10/922874 | 7234795 | 10/922871 |
| 10/922880 | 7293855 | 10/922882 | 10/922883 | 10/922878 | 10/922872 | 10/922876 |
| 10/922886 | 10/922877 | 7147792 | 7175774 | 11/159193 | 11/491378 | 11766713 |
| 11/841647 | 11/482980 | 11/563684 | 11/482967 | 11/482966 | 11/482988 | 11/482989 |
| 11/293832 | 11/293838 | 11/293825 | 11/293841 | 11/293799 | 11/293796 | 11/293797 |
| 11/293798 | 11/124158 | 11/124196 | 11/124199 | 11/124162 | 11/124202 | 11/124197 |
| 11/124154 | 11/124198 | 7284921 | 11/124151 | 11/124160 | 11/124192 | 11/124175 |
| 11/124163 | 11/124149 | 11/124152 | 11/124173 | 11/124155 | 7236271 | 11/124174 |
| 11/124194 | 11/124164 | 11/124200 | 11/124195 | 11/124166 | 11/124150 | 11/124172 |
| 11/124165 | 11/124186 | 11/124185 | 11/124184 | 11/124182 | 11/124201 | 11/124171 |
| 11/124181 | 11/124161 | 11/124156 | 11/124191 | 11/124159 | 11/124176 | 11/124188 |
| 11/124170 | 11/124187 | 11/124189 | 11/124190 | 11/124180 | 11/124193 | 11/124183 |
| 11/124178 | 11/124177 | 11/124148 | 11/124168 | 11/124167 | 11/124179 | 11/124169 |
| 11/187976 | 11/188011 | 11/188014 | 11/482979 | 11/735490 | 11/853018 | 11/944450 |
| 11/228540 | 11/228500 | 11/228501 | 11/228530 | 11/228490 | 11/228531 | 11/228504 |
| 11/228533 | 11/228502 | 11/228507 | 11/228482 | 11/228505 | 11/228497 | 11/228487 |
| 11/228529 | 11/228484 | 11/228489 | 11/228518 | 11/228536 | 11/228496 | 11/228488 |
| 11/228506 | 11/228516 | 11/228526 | 11/228539 | 11/228538 | 11/228524 | 11/228523 |
| 11/228519 | 11/228528 | 11/228527 | 11/228525 | 11/228520 | 11/228498 | 11/228511 |
| 11/228522 | 11/228515 | 11/228537 | 11/228534 | 11/228491 | 11/228499 | 11/228509 |
| 11/228492 | 11/228493 | 11/228510 | 11/228508 | 11/228512 | 11/228514 | 11/228494 |
| 11/228495 | 11/228486 | 11/228481 | 11/228477 | 11/228485 | 11/228483 | 11/228521 |
| 11/228517 | 11/228532 | 11/228513 | 11/228503 | 11/228480 | 11/228535 | 11/228478 |
| 11/228479 | 6238115 | 6386535 | 6398344 | 6612240 | 6752549 | 6805049 |
| 6971313 | 6899480 | 6860664 | 6925935 | 6966636 | 7024995 | 7284852 |
| 6926455 | 7056038 | 6869172 | 7021843 | 6988845 | 6964533 | 6981809 |
| 7284822 | 7258067 | 11/155544 | 7222941 | 7284925 | 7278795 | 7249904 |
| 11/737726 | 11772240 | 11/863246 | 11/863145 | 11/865650 | 6087638 | 6340222 |
| 6041600 | 6299300 | 6067797 | 6286935 | 6044646 | 6382769 | 6787051 |
| 6938990 | 11/242916 | 11/144799 | 11/198235 | 11861282 | 11861284 | 11/766052 |
| 7152972 | 11/592996 | D529952 | 6390605 | 6322195 | 6612110 | 6480089 |
| 6460778 | 6305788 | 6426014 | 6364453 | 6457795 | 6315399 | 6338548 |
| 7040736 | 6938992 | 6994425 | 6863379 | 6540319 | 6994421 | 6984019 |
| 7008043 | 6997544 | 6328431 | 6991310 | 10/965772 | 7140723 | 6328425 |
| 6982184 | 7267423 | 7134741 | 7066577 | 7152945 | 11/038200 | 7021744 |
| 6991320 | 7155911 | 11/107799 | 6595624 | 7152943 | 7125103 | 11/209709 |
| 7290857 | 7285437 | 7229151 | 11/330058 | 7237873 | 11/329163 | 11/442180 |
| 11/450431 | 7213907 | 6417757 | 11/482951 | 11/545566 | 11/583826 | 11/604315 |
| 11/604323 | 11/643845 | 11/706950 | 11/730399 | 11749121 | 11/753549 | 11/834630 |
| 11/935389 | 11/869670 | 7095309 | 11/945157 | 11957473 | 11967235 | 6854825 |
| 6623106 | 6672707 | 6575561 | 6817700 | 6588885 | 7075677 | 6428139 |
| 6575549 | 6846692 | 6425971 | 7063993 | 6383833 | 6955414 | 6412908 |
| 6746105 | 6953236 | 6412904 | 7128388 | 6398343 | 6652071 | 6793323 |
| 6659590 | 6676245 | 7201460 | 6464332 | 6659593 | 6478406 | 6978613 |
| 6439693 | 6502306 | 6966111 | 6863369 | 6428142 | 6874868 | 6390591 |
| 6799828 | 6896358 | 7018016 | 10/296534 | 6328417 | 6322194 | 6382779 |
| 6629745 | 6565193 | 6609786 | 6609787 | 6439908 | 6684503 | 6843551 |
| 6764166 | 6561617 | 10/510092 | 6557970 | 6546628 | 10/510098 | 6652074 |
| 6820968 | 7175260 | 6682174 | 7303262 | 6648453 | 6834932 | 6682176 |
| 6998062 | 6767077 | 7278717 | 6755509 | 10/534813 | 6692108 | 10/534811 |
| 6672709 | 7303263 | 7086718 | 10/534881 | 6672710 | 10/534812 | 6669334 |
| 10/534804 | 7152958 | 7281782 | 6824246 | 7264336 | 6669333 | 10/534815 |
| 6820967 | 7306326 | 6736489 | 7264335 | 6719406 | 7222943 | 7188419 |
| 7168166 | 6974209 | 7086719 | 6974210 | 7195338 | 7252775 | 7101025 |
| 11/474281 | 11/485258 | 11/706304 | 11/706324 | 11/706326 | 11/706321 | 11/772239 |
| 11/782598 | 11/829941 | 11/852991 | 11852986 | 11/936062 | 11/934027 | 11955028 |
| 11/763440 | 11/763442 | 11/246687 | 11/246718 | 11/246685 | 11/246686 | 11/246703 |
| 11/246691 | 11/246711 | 11/246690 | 11/246712 | 11/246717 | 11/246709 | 11/246700 |
| 11/246701 | 11/246702 | 11/246668 | 11/246697 | 11/246698 | 11/246699 | 11/246675 |
| 11/246674 | 11/246667 | 11/829957 | 11/829960 | 11/829961 | 11/829962 | 11/829963 |
| 11/829966 | 11/829967 | 11/829968 | 11/829969 | 11946839 | 11946838 | 11946837 |
| 11951230 | 7156508 | 7159972 | 7083271 | 7165834 | 7080894 | 7201469 |
| 7090336 | 7156489 | 10/760233 | 10/760246 | 7083257 | 7258422 | 7255423 |
| 7219980 | 10/760253 | 10/760255 | 10/760209 | 7118192 | 10/760194 | 10/760238 |
| 7077505 | 7198354 | 7077504 | 10/760189 | 7198355 | 10/760232 | 10/760231 |
| 7152959 | 7213906 | 7178901 | 7222938 | 7108353 | 7104629 | 11/446227 |
| 11/454904 | 11/472345 | 11/474273 | 7261401 | 11/474279 | 11/482939 | 11/482950 |
| 11/499709 | 7306324 | 7306325 | 11/603824 | 11/601756 | 11/601672 | 7303261 |
| 11/653253 | 11/706328 | 11/706299 | 11/706965 | 11/737080 | 11/737041 | 11/778062 |
| 11/778566 | 11/782593 | 11/934018 | 11/945157 | 11951095 | 11951828 | 11954906 |
| 11954949 | 11967226 | 7303930 | 11/246672 | 11/246673 | 11/246683 | 11/246682 |
| 60/939086 | 11860538 | 11860539 | 11/860540 | 11860541 | 11860542 | 11/936060 |
| 11877667 | 11877668 | 7246886 | 7128400 | 7108355 | 6991322 | 7287836 |
| 7118197 | 10/728784 | 10/728783 | 7077493 | 6962402 | 10/728803 | 7147308 |
| 10/728779 | 7118198 | 7168790 | 7172270 | 7229155 | 6830318 | 7195342 |
| 7175261 | 10/773183 | 7108356 | 7118202 | 10/773186 | 7134744 | 10/773185 |
| 7134743 | 7182439 | 7210768 | 10/773187 | 7134745 | 7156484 | 7118201 |
| 7111926 | 10/773184 | 7018021 | 11/060751 | 11/060805 | 11/188017 | 7128402 |
| 11/298774 | 11/329157 | 11/490041 | 11/501767 | 7284839 | 7246885 | 7229156 |
| 11/505846 | 11/505857 | 7293858 | 11/524908 | 11/524938 | 7258427 | 11/524912 |
| 7278716 | 11/592995 | 11/603825 | 11/649773 | 11/650549 | 11/653237 | 11/706378 |
| 11/706962 | 11749118 | 11/754937 | 11749120 | 11/744885 | 11/779850 | 11/765439 |
| 11/842950 | 11/839539 | 11/926121 | 11/097308 | 11/097309 | 7246876 | 11/097299 |
| 11/097310 | 11/097213 | 11/210687 | 11/097212 | 7147306 | 7261394 | 11/764806 |
| 11/782595 | 11965696 | 11/482953 | 11/482977 | 11/544778 | 11/544779 | 11/764808 |
| 11/756624 | 11/756625 | 11/756626 | 11/756627 | 11/756628 | 11/756629 | 11/756630 |
| 11/756631 | 7156289 | 7178718 | 7225979 | 11/712434 | 11/084796 | 11/084742 |
| 11/084806 | 09/575197 | 09/575197 | 7079712 | 7079712 | 6825945 | 6825945 |
| 09/575165 | 09/575165 | 6813039 | 6813039 | 7190474 | 7190474 | 6987506 |
| 6987506 | 6824044 | 6824044 | 7038797 | 7038797 | 6980318 | 6980318 |
| 6816274 | 6816274 | 7102772 | 7102772 | 09/575186 | 09/575186 | 6681045 |
| 6681045 | 6678499 | 6678499 | 6679420 | 6679420 | 6963845 | 6963845 |
| 6976220 | 6976220 | 6728000 | 6728000 | 7110126 | 7110126 | 7173722 |
| 7173722 | 6976035 | 6976035 | 6813558 | 6813558 | 6766942 | 6766942 |
| 6965454 | 6965454 | 6995859 | 6995859 | 7088459 | 7088459 | 6720985 |
| 6720985 | 7286113 | 7286113 | 6922779 | 6922779 | 6978019 | 6978019 |
| 6847883 | 6847883 | 7131058 | 7131058 | 7295839 | 7295839 | 09/607843 |
| 09/607843 | 09/693690 | 09/693690 | 6959298 | 6959298 | 6973450 | 6973450 |
| 7150404 | 7150404 | 6965882 | 6965882 | 7233924 | 7233924 | 09/575181 |
| 09/575181 | 09/722174 | 09/722174 | 7175079 | 7175079 | 7162259 | 6718061 |
| 10/291523 | 10/291471 | 7012710 | 6825956 | 10/291481 | 7222098 | 10/291825 |
| 7263508 | 7031010 | 6972864 | 6862105 | 7009738 | 6989911 | 6982807 |
| 10/291576 | 6829387 | 6714678 | 6644545 | 6609653 | 6651879 | 10/291555 |
| 7293240 | 10/291592 | 10/291542 | 7044363 | 7004390 | 6867880 | 7034953 |
| 6987581 | 7216224 | 10/291821 | 7162269 | 7162222 | 7290210 | 7293233 |
| 7293234 | 6850931 | 6865570 | 6847961 | 10/685523 | 10/685583 | 7162442 |
| 10/685584 | 7159784 | 10/804034 | 10/793933 | 6889896 | 10/831232 | 7174056 |
| 6996274 | 7162088 | 10/943874 | 10/943872 | 10/944044 | 7259884 | 10/944043 |
| 7167270 | 10/943877 | 6986459 | 10/954170 | 7181448 | 10/981626 | 10/981616 |
| 10/981627 | 7231293 | 7174329 | 10/992713 | 7295922 | 7200591 | 11/020106 |
| 11/020260 | 11/020321 | 11/020319 | 11/026045 | 11/059696 | 11/051032 | 11/059674 |
| 11/107944 | 11/107941 | 11/082940 | 11/082815 | 11/082827 | 11/082829 | 6991153 |
| 6991154 | 11/124256 | 11/123136 | 11/154676 | 11/159196 | 11/182002 | 11/202251 |
| 11/202252 | 11/202253 | 11/203200 | 11/202218 | 11/206778 | 11/203424 | 11/222977 |
| 11/228450 | 11/227239 | 11/286334 | 7225402 | 11/329187 | 11/349143 | 11/491225 |
| 11/491121 | 11/442428 | 11/454902 | 11/442385 | 11/478590 | 7271931 | 11/520170 |
| 11/603057 | 11/706964 | 11/739032 | 11739014 | 11/834633 | 11/830848 | 11/830849 |
| 11/839542 | 11/866394 | 11/934077 | 11951874 | 7068382 | 7068382 | 7007851 |
| 7007851 | 6957921 | 6957921 | 6457883 | 6457883 | 10/743671 | 7044381 |
| 11/203205 | 7094910 | 7091344 | 7122685 | 7038066 | 7099019 | 7062651 |
| 7062651 | 6789194 | 6789194 | 6789191 | 6789191 | 10/900129 | 7278018 |
| 10/913350 | 10/982975 | 10/983029 | 11/331109 | 6644642 | 6644642 | 6502614 |
| 6502614 | 6622999 | 6622999 | 6669385 | 6669385 | 6827116 | 7011128 |
| 10/949307 | 6549935 | 6549935 | 6987573 | 6987573 | 6727996 | 6727996 |
| 6591884 | 6591884 | 6439706 | 6439706 | 6760119 | 6760119 | 7295332 |
| 7295332 | 7064851 | 7064851 | 6826547 | 6826547 | 6290349 | 6290349 |
| 6428155 | 6428155 | 6785016 | 6785016 | 6831682 | 6831682 | 6741871 |
| 6741871 | 6927871 | 6927871 | 6980306 | 6980306 | 6965439 | 6965439 |
| 6840606 | 7036918 | 6977746 | 6970264 | 7068389 | 7093991 | 7190491 |
| 10/901154 | 10/932044 | 10/962412 | 7177054 | 10/962552 | 10/965733 | 10/965933 |
| 10/974742 | 10/982974 | 7180609 | 10/986375 | 11/107817 | 7292363 | 11/149160 |
| 11/206756 | 11/250465 | 7202959 | 11/653219 | 11/706309 | 11/730389 | 11/730392 |
| 60/953443 | 11/866387 | 60974077 | 6982798 | 6982798 | 6870966 | 6870966 |
| 6822639 | 6822639 | 6474888 | 6474888 | 6627870 | 6627870 | 6724374 |
| 6724374 | 6788982 | 6788982 | 7263270 | 7263270 | 6788293 | 6788293 |
| 6946672 | 6946672 | 6737591 | 6737591 | 7091960 | 7091960 | 09/693514 |
| 09/693514 | 6792165 | 6792165 | 7105753 | 7105753 | 6795593 | 6980704 |
| 6768821 | 7132612 | 7041916 | 6797895 | 7015901 | 7289882 | 7148644 |
| 10/778056 | 10/778058 | 10/778060 | 10/778059 | 10/778063 | 10/778062 | 10/778061 |
| 10/778057 | 7096199 | 7286887 | 10/917467 | 10/917466 | 10/917465 | 7218978 |
| 7245294 | 7277085 | 7187370 | 10/917436 | 10/943856 | 10/919379 | 7019319 |
| 10/943878 | 10/943849 | 7043096 | 7148499 | 11/144840 | 11/155556 | 11/155557 |
| 11/193481 | 11/193435 | 11/193482 | 11/193479 | 11/255941 | 11/281671 | 11/298474 |
| 7245760 | 11/488832 | 11/495814 | 11/495823 | 11/495822 | 11/495821 | 11/495820 |
| 11/653242 | 11/754370 | 60911260 | 11/829936 | 11/839494 | 11866305 | 11866313 |
| 11866324 | 11866336 | 11866348 | 11866359 | 11970951 | 7055739 | 7055739 |
| 7233320 | 7233320 | 6830196 | 6830196 | 6832717 | 6832717 | 7182247 |
| 7182247 | 7120853 | 7082562 | 6843420 | 10/291718 | 6789731 | 7057608 |
| 6766944 | 6766945 | 7289103 | 10/291559 | 7299969 | 7264173 | 10/409864 |
| 7108192 | 10/537159 | 7111791 | 7077333 | 6983878 | 10/786631 | 7134598 |
| 10/893372 | 6929186 | 6994264 | 7017826 | 7014123 | 7134601 | 7150396 |
| 10/971146 | 7017823 | 7025276 | 7284701 | 7080780 | 11/074802 | 11/442366 |
| 11749158 | 11/842948 | 10/492169 | 10/492152 | 10/492168 | 10/492161 | 7308148 |
| 10/502575 | 10/531229 | 10/683151 | 10/531733 | 10/683040 | 10/510391 | 10/919260 |
| 10/510392 | 10/778090 | 11/944404 | 11/936638 | 6957768 | 6957768 | 09/575172 |
| 09/575172 | 7170499 | 7170499 | 7106888 | 7106888 | 7123239 | 7123239 |
| 6982701 | 6982703 | 7227527 | 6786397 | 6947027 | 6975299 | 7139431 |
| 7048178 | 7118025 | 6839053 | 7015900 | 7010147 | 7133557 | 6914593 |
| 10/291546 | 6938826 | 7278566 | 7123245 | 6992662 | 7190346 | 11/074800 |
| 11/074782 | 11/074777 | 11/075917 | 7221781 | 11/102843 | 7213756 | 11/188016 |
| 7180507 | 7263225 | 7287688 | 11/737094 | 11/753570 | 11/782596 | 11/865711 |
| 11856061 | 11856062 | 11856064 | 11856066 | 11/672522 | 11/672950 | 11/672947 |
| 11/672891 | 11/672954 | 11/672533 | 11754310 | 11/754321 | 11/754320 | 11/754319 |
| 11/754318 | 11/754317 | 11/754316 | 11/754315 | 11/754314 | 11/754313 | 11/754312 |
| 11/754311 | 6593166 | 6593166 | 7132679 | 6940088 | 7119357 | 7307272 |
| 6755513 | 6974204 | 6409323 | 7055930 | 6281912 | 6893109 | 6604810 |
| 6824242 | 6318920 | 7210867 | 6488422 | 6655786 | 6457810 | 6485135 |
| 6796731 | 6904678 | 6641253 | 7125106 | 6786658 | 7097273 | 6824245 |
| 7222947 | 6918649 | 6860581 | 6929351 | 7063404 | 6969150 | 7004652 |
| 6871938 | 6905194 | 6846059 | 6997626 | 10/974881 | 7029098 | 6966625 |
| 7114794 | 7207646 | 7077496 | 7284831 | 11/072529 | 7152938 | 7182434 |
| 7182430 | 7306317 | 7032993 | 11/155513 | 11/155545 | 11/144813 | 7172266 |
| 7258430 | 7128392 | 7210866 | 7306322 | 11/505933 | 11/540727 | 11/635480 |
| 11/707946 | 11/706303 | 11/709084 | 11/730776 | 11/744143 | 11/779845 | 11/782589 |
| 11/863256 | 11/940302 | 11/940235 | 11955359 | 11/066161 | 11/066160 | 11/066159 |
| 11/066158 | 7287831 | 11/875936 | 6804030 | 6807315 | 6771811 | 6683996 |
| 7271936 | 7304771 | 6965691 | 7058219 | 7289681 | 7187807 | 7181063 |
| 11/338783 | 11/603823 | 11/650536 | 10/727181 | 10/727162 | 10/727163 | 10/727245 |
| 7121639 | 7165824 | 7152942 | 10/727157 | 7181572 | 7096137 | 7302592 |
| 7278034 | 7188282 | 10/727159 | 10/727180 | 10/727179 | 10/727192 | 10/727274 |
| 10/727164 | 10/727161 | 10/727198 | 10/727158 | 10/754536 | 10/754938 | 10/727227 |
| 10/727160 | 10/934720 | 7171323 | 7278697 | 11/442131 | 11/474278 | 11/488853 |
| 11/488841 | 11749750 | 11749749 | 11955127 | 11951213 | 10/296522 | 6795215 |
| 7070098 | 7154638 | 6805419 | 6859289 | 6977751 | 6398332 | 6394573 |
| 6622923 | 6747760 | 6921144 | 10/884881 | 7092112 | 7192106 | 11/039866 |
| 7173739 | 6986560 | 7008033 | 11/148237 | 7222780 | 7270391 | 7150510 |
| 11/478599 | 11/499749 | 11/521388 | 11/738518 | 11/482981 | 11/743662 | 11/743661 |
| 11/743659 | 11/743655 | 11/743657 | 11/752900 | 11926109 | 11/927163 | 11929567 |
| 7195328 | 7182422 | 11/650537 | 11/712540 | 10/854521 | 10/854522 | 10/854488 |
| 7281330 | 10/854503 | 10/854504 | 10/854509 | 7188928 | 7093989 | 10/854497 |
| 10/854495 | 10/854498 | 10/854511 | 10/854512 | 10/854525 | 10/854526 | 10/854516 |
| 7252353 | 10/854515 | 7267417 | 10/854505 | 10/854493 | 7275805 | 7314261 |
| 10/854490 | 7281777 | 7290852 | 10/854528 | 10/854523 | 10/854527 | 10/854524 |
| 10/854520 | 10/854514 | 10/854519 | 10/854513 | 10/854499 | 10/854501 | 7266661 |
| 7243193 | 10/854518 | 10/854517 | 10/934628 | 7163345 | 11/499803 | 11/601757 |
| 11/706295 | 11/735881 | 11748483 | 11749123 | 11/766061 | 11775135 | 11772235 |
| 11/778569 | 11/829942 | 11/870342 | 11/935274 | 11/937239 | 11961907 | 11961940 |
| 11961961 | 11/014731 | D529081 | D541848 | D528597 | 6924907 | 6712452 |
| 6416160 | 6238043 | 6958826 | 6812972 | 6553459 | 6967741 | 6956669 |
| 6903766 | 6804026 | 7259889 | 6975429 | 10/636234 | 10/636233 | 7301567 |
| 10/636216 | 7274485 | 7139084 | 7173735 | 7068394 | 7286182 | 7086644 |
| 7250977 | 7146281 | 7023567 | 7136183 | 7083254 | 6796651 | 7061643 |
| 7057758 | 6894810 | 6995871 | 7085010 | 7092126 | 7123382 | 7061650 |
| 10/853143 | 6986573 | 6974212 | 7307756 | 7173737 | 10/954168 | 7246868 |
| 11/065357 | 7137699 | 11/107798 | 7148994 | 7077497 | 11/176372 | 7248376 |
| 11/225158 | 7306321 | 7173729 | 11/442132 | 11/478607 | 11/503085 | 11/545502 |
| 11/583943 | 11/585946 | 11/653239 | 11/653238 | 11/764781 | 11/764782 | 11/779884 |
| 11845666 | 11/872637 | 11/944401 | 11/940215 | 11/544764 | 11/544765 | 11/544772 |
| 11/544773 | 11/544774 | 11/544775 | 11/544776 | 11/544766 | 11/544767 | 11/544771 |
| 11/544770 | 11/544769 | 11/544777 | 11/544768 | 11/544763 | 11/293804 | 11/293840 |
| 11/293803 | 11/293833 | 11/293834 | 11/293835 | 11/293836 | 11/293837 | 11/293792 |
| 11/293794 | 11/293839 | 11/293826 | 11/293829 | 11/293830 | 11/293827 | 11/293828 |
| 7270494 | 11/293823 | 11/293824 | 11/293831 | 11/293815 | 11/293819 | 11/293818 |
| 11/293817 | 11/293816 | 11/838875 | 11/482978 | 11/640356 | 11/640357 | 11/640358 |
| 11/640359 | 11/640360 | 11/640355 | 11/679786 | 11/872714 | 10/760254 | 10/760210 |
| 10/760202 | 7201468 | 10/760198 | 10/760249 | 7234802 | 7303255 | 7287846 |
| 7156511 | 10/760264 | 7258432 | 7097291 | 10/760222 | 10/760248 | 7083273 |
| 10/760192 | 10/760203 | 10/760204 | 10/760205 | 10/760206 | 10/760267 | 10/760270 |
| 7198352 | 10/760271 | 7303251 | 7201470 | 7121655 | 7293861 | 7232208 |
| 10/760186 | 10/760261 | 7083272 | 7261400 | 11/474272 | 11/474315 | 7311387 |
| 11/583874 | 7303258 | 11/706322 | 11/706968 | 11/749119 | 11749157 | 11779848 |
| 11/782590 | 11/855152 | 11855151 | 11/870327 | 11/934780 | 11/935992 | 11951193 |
| 11/014764 | 11/014763 | 11/014748 | 11/014747 | 11/014761 | 11/014760 | 11/014757 |
| 7303252 | 7249822 | 11/014762 | 11/014724 | 11/014723 | 11/014756 | 11/014736 |
| 11/014759 | 11/014758 | 11/014725 | 11/014739 | 11/014738 | 11/014737 | 11/014726 |
| 11/014745 | 11/014712 | 7270405 | 7303268 | 11/014735 | 11/014734 | 11/014719 |
| 11/014750 | 11/014749 | 7249833 | 11/758640 | 11/775143 | 11/838877 | 11944453 |
| 11/944633 | 11955065 | 11/014769 | 11/014729 | 11/014743 | 11/014733 | 7300140 |
| 11/014755 | 11/014765 | 11/014766 | 11/014740 | 7284816 | 7284845 | 7255430 |
| 11/014744 | 11/014741 | 11/014768 | 11/014767 | 11/014718 | 11/014717 | 11/014716 |
| 11/014732 | 11/014742 | 11/097268 | 11/097185 | 11/097184 | 11/778567 | 11852958 |
| 11852907 | 11/872038 | 11955093 | 11961578 | 11/293820 | 11/293813 | 11/293822 |
| 11/293812 | 11/293821 | 11/293814 | 11/293793 | 11/293842 | 11/293811 | 11/293807 |
| 11/293806 | 11/293805 | 11/293810 | 11/688863 | 11/688864 | 11/688865 | 11/688866 |
| 11/688867 | 11/688868 | 11/688869 | 11/688871 | 11/688872 | 11/688873 | 11/741766 |
| 11/482982 | 11/482983 | 11/482984 | 11/495818 | 11/495819 | 11/677049 | 11/677050 |
| 11/677051 | 11872719 | 11872718 | 7306320 | 11/934781 | D528156 | 10/760180 |
| 7111935 | 10/760213 | 10/760219 | 10/760237 | 7261482 | 10/760220 | 7002664 |
| 10/760252 | 10/760265 | 7088420 | 11/446233 | 11/503083 | 11/503081 | 11/516487 |
| 11/599312 | 6364451 | 6533390 | 6454378 | 7224478 | 6559969 | 6896362 |
| 7057760 | 6982799 | 11/202107 | 11/743672 | 11744126 | 11/743673 | 7093494 |
| 7143652 | 7089797 | 7159467 | 7234357 | 7124643 | 7121145 | 7089790 |
| 7194901 | 6968744 | 7089798 | 7240560 | 7137302 | 11/442177 | 7171855 |
| 7260995 | 7260993 | 7165460 | 7222538 | 7258019 | 11/543047 | 7258020 |
| 11/604324 | 11/642520 | 11/706305 | 11/707056 | 11744211 | 11/767526 | 11/779846 |
| 11/764227 | 11/829943 | 11/829944 | 6454482 | 6454482 | 6808330 | 6808330 |
| 6527365 | 6527365 | 6474773 | 6474773 | 6550997 | 6550997 | 7093923 |
| 6957923 | 7131724 | 10/949288 | 7168867 | 7125098 | 11/706966 | 11/185722 |
| 7249901 | 7188930 | 11/014728 | 11/014727 | D536031 | D531214 | 7237888 |
| 7168654 | 7201272 | 6991098 | 7217051 | 6944970 | 10/760215 | 7108434 |
| 10/760257 | 7210407 | 7186042 | 10/760266 | 6920704 | 7217049 | 10/760214 |
| 10/760260 | 7147102 | 7287828 | 7249838 | 10/760241 | 10/962413 | 10/962427 |
| 7261477 | 7225739 | 10/962402 | 10/962425 | 10/962428 | 7191978 | 10/962426 |
| 10/962409 | 10/962417 | 10/962403 | 7163287 | 7258415 | 10/962523 | 7258424 |
| 10/962410 | 7195412 | 7207670 | 7270401 | 7220072 | 11/474267 | 11/544547 |
| 11/585925 | 11/593000 | 11/706298 | 11/706296 | 11/706327 | 11/730760 | 11/730407 |
| 11/730787 | 11/735977 | 11/736527 | 11/753566 | 11/754359 | 11/778061 | 11/765398 |
| 11/778556 | 11/829937 | 11/780470 | 11/866399 | 11/223262 | 11/223018 | 11/223114 |
| 11955366 | 11/223022 | 11/223021 | 11/223020 | 11/223019 | 11/014730 | D541849 |
| 29/279123 | 6716666 | 6949217 | 6750083 | 7014451 | 6777259 | 6923524 |
| 6557978 | 6991207 | 6766998 | 6967354 | 6759723 | 6870259 | 10/853270 |
| 6925875 | 10/898214 | 7095109 | 7145696 | 10/976081 | 7193482 | 7134739 |
| 7222939 | 7164501 | 7118186 | 7201523 | 7226159 | 7249839 | 7108343 |
| 7154626 | 7079292 | 10/980184 | 7233421 | 7063408 | 10/983082 | 10/982804 |
| 7032996 | 10/982834 | 10/982833 | 10/982817 | 7217046 | 6948870 | 7195336 |
| 7070257 | 10/986813 | 10/986785 | 7093922 | 6988789 | 10/986788 | 7246871 |
| 10/992748 | 10/992747 | 7187468 | 10/992828 | 7196814 | 10/992754 | 7268911 |
| 7265869 | 7128384 | 7164505 | 7284805 | 7025434 | 7298519 | 7280244 |
| 7206098 | 7265877 | 7193743 | 7168777 | 11/006734 | 7195329 | 7198346 |
| 7281786 | 11/013363 | 11/013881 | 6959983 | 7128386 | 7097104 | 11/013636 |
| 7083261 | 7070258 | 7083275 | 7110139 | 6994419 | 6935725 | 11/026046 |
| 7178892 | 7219429 | 6988784 | 11/026135 | 7289156 | 11/064005 | 7284976 |
| 7178903 | 7273274 | 7083256 | 11/064008 | 7278707 | 11/064013 | 6974206 |
| 11/064004 | 7066588 | 7222940 | 11/075918 | 7018025 | 7221867 | 7290863 |
| 7188938 | 7021742 | 7083262 | 7192119 | 11/083021 | 7036912 | 7175256 |
| 7182441 | 7083258 | 7114796 | 7147302 | 11/084757 | 7219982 | 7118195 |
| 7229153 | 6991318 | 7108346 | 11/248429 | 11/239031 | 7178899 | 7066579 |
| 11/281419 | 11/298633 | 11/329188 | 11/329140 | 7270397 | 7258425 | 7237874 |
| 7152961 | 11/478592 | 7207658 | 11/484744 | 7311257 | 7207659 | 11/525857 |
| 11/540569 | 11/583869 | 11/592985 | 11/585947 | 7306307 | 11/604316 | 11/604309 |
| 11/604303 | 11/643844 | 11/650553 | 11/655940 | 11/653320 | 7278713 | 11/706381 |
| 11/706323 | 11/706963 | 11/713660 | 7290853 | 11/696186 | 11/730390 | 11/737139 |
| 11/737749 | 11/740273 | 11749122 | 11/754361 | 11766043 | 11/764775 | 11/768872 |
| 11/775156 | 11/779271 | 11/779272 | 11/829938 | 11/839502 | 11858852 | 11/862188 |
| 11859790 | 11/872618 | 11/923651 | 11950255 | 11930001 | 11955362 | 11965718 |
| 6485123 | 6425657 | 6488358 | 7021746 | 6712986 | 6981757 | 6505912 |
| 6439694 | 6364461 | 6378990 | 6425658 | 6488361 | 6814429 | 6471336 |
| 6457813 | 6540331 | 6454396 | 6464325 | 6443559 | 6435664 | 6412914 |
| 6488360 | 6550896 | 6439695 | 6447100 | 09/900160 | 6488359 | 6637873 |
| 10/485738 | 6618117 | 10/485737 | 6803989 | 7234801 | 7044589 | 7163273 |
| 6416154 | 6547364 | 10/485744 | 6644771 | 7152939 | 6565181 | 10/485805 |
| 6857719 | 7255414 | 6702417 | 7284843 | 6918654 | 7070265 | 6616271 |
| 6652078 | 6503408 | 6607263 | 7111924 | 6623108 | 6698867 | 6488362 |
| 6625874 | 6921153 | 7198356 | 6536874 | 6425651 | 6435667 | 10/509997 |
| 6527374 | 10/510154 | 6582059 | 10/510152 | 6513908 | 7246883 | 6540332 |
| 6547368 | 7070256 | 6508546 | 10/510151 | 6679584 | 10/510000 | 6857724 |
| 10/509998 | 6652052 | 10/509999 | 6672706 | 10/510096 | 6688719 | 6712924 |
| 6588886 | 7077508 | 7207654 | 6935724 | 6927786 | 6988787 | 6899415 |
| 6672708 | 6644767 | 6874866 | 6830316 | 6994420 | 6954254 | 7086720 |
| 7240992 | 7267424 | 7128397 | 7084951 | 7156496 | 7066578 | 7101023 |
| 11/165027 | 11/202235 | 11/225157 | 7159965 | 7255424 | 11/349519 | 7137686 |
| 7201472 | 7287829 | 11/504602 | 7216957 | 11/520572 | 11/583858 | 11/583895 |
| 11/585976 | 11/635488 | 7278712 | 11/706952 | 11/706307 | 7287827 | 11944451 |
| 11/740287 | 11/754367 | 11/758643 | 11/778572 | 11859791 | 11/863260 | 11/874178 |
| 11/936064 | 11951983 | 6916082 | 6786570 | 10/753478 | 6848780 | 6966633 |
| 7179395 | 6969153 | 6979075 | 7132056 | 6832828 | 6860590 | 6905620 |
| 6786574 | 6824252 | 7097282 | 6997545 | 6971734 | 6918652 | 6978990 |
| 6863105 | 10/780624 | 7194629 | 10/791792 | 6890059 | 6988785 | 6830315 |
| 7246881 | 7125102 | 7028474 | 7066575 | 6986202 | 7044584 | 7210762 |
| 7032992 | 7140720 | 7207656 | 7285170 | 11/048748 | 7008041 | 7011390 |
| 7048868 | 7014785 | 7131717 | 7284826 | 11/176158 | 7182436 | 7104631 |
| 7240993 | 7290859 | 11/202217 | 7172265 | 7284837 | 7066573 | 11/298635 |
| 7152949 | 11/442161 | 11/442133 | 11/442126 | 7156492 | 11/478588 | 11/505848 |
| 7287834 | 11/525861 | 11/583939 | 11/545504 | 7284326 | 11/635485 | 11/730391 |
| 11/730788 | 11/749148 | 11/749149 | 11/749152 | 11/749151 | 11/759886 | 11/865668 |
| 11/874168 | 11/874203 | 11971182 | 11965722 | 6824257 | 7270475 | 6971811 |
| 6878564 | 6921145 | 6890052 | 7021747 | 6929345 | 6811242 | 6916087 |
| 6905195 | 6899416 | 6883906 | 6955428 | 7284834 | 6932459 | 6962410 |
| 7033008 | 6962409 | 7013641 | 7204580 | 7032997 | 6998278 | 7004563 |
| 6910755 | 6969142 | 6938994 | 7188935 | 10/959049 | 7134740 | 6997537 |
| 7004567 | 6916091 | 7077588 | 6918707 | 6923583 | 6953295 | 6921221 |
| 7001008 | 7168167 | 7210759 | 11/008115 | 11/011120 | 11/012329 | 6988790 |
| 7192120 | 7168789 | 7004577 | 7052120 | 11/123007 | 6994426 | 7258418 |
| 7014298 | 11/124348 | 11/177394 | 7152955 | 7097292 | 7207657 | 7152944 |
| 7147303 | 11/209712 | 7134608 | 7264333 | 7093921 | 7077590 | 7147297 |
| 11/239029 | 11/248832 | 11/248428 | 11/248434 | 7077507 | 7172672 | 7175776 |
| 7086717 | 7101020 | 11/329155 | 7201466 | 11/330057 | 7152967 | 7182431 |
| 7210666 | 7252367 | 7287837 | 11/485255 | 11/525860 | 6945630 | 7018294 |
| 6910014 | 6659447 | 6648321 | 7082980 | 6672584 | 7073551 | 6830395 |
| 7289727 | 7001011 | 6880922 | 6886915 | 6644787 | 6641255 | 7066580 |
| 6652082 | 7284833 | 6666544 | 6666543 | 6669332 | 6984023 | 6733104 |
| 6644793 | 6723575 | 6953235 | 6663225 | 7076872 | 7059706 | 7185971 |
| 7090335 | 6854827 | 6793974 | 10/636258 | 7222929 | 6739701 | 7073881 |
| 7155823 | 7219427 | 7008503 | 6783216 | 6883890 | 6857726 | 10/636274 |
| 6641256 | 6808253 | 6827428 | 6802587 | 6997534 | 6959982 | 6959981 |
| 6886917 | 6969473 | 6827425 | 7007859 | 6802594 | 6792754 | 6860107 |
| 6786043 | 6863378 | 7052114 | 7001007 | 10/729151 | 10/729157 | 6948794 |
| 6805435 | 6733116 | 10/683006 | 7008046 | 6880918 | 7066574 | 6983595 |
| 6923527 | 7275800 | 7163276 | 7156495 | 6976751 | 6994430 | 7014296 |
| 7059704 | 7160743 | 7175775 | 7287839 | 7097283 | 7140722 | 11/123009 |
| 11/123008 | 7080893 | 7093920 | 7270492 | 7128093 | 7052113 | 7055934 |
| 11/155627 | 7278796 | 11/159197 | 7083263 | 7145592 | 7025436 | 11/281444 |
| 7258421 | 11/478591 | 11/478735 | 7226147 | 11/482940 | 7195339 | 11/503061 |
| 11/505938 | 7284838 | 7293856 | 11/544577 | 11/540576 | 11/585964 | 11/592991 |
| 11/599342 | 11/600803 | 11/604321 | 11/604302 | 11/635535 | 11/635486 | 11/643842 |
| 11/655987 | 11/650541 | 11/706301 | 11/707039 | 11/730388 | 11/730786 | 11/730785 |
| 11/739080 | 11/764746 | 11/768875 | 11/779847 | 11/829940 | 11847240 | 11/834625 |
| 11/863210 | 11/865680 | 11/874156 | 11/923602 | 11951940 | 11954988 | 11961662 |
| 7067067 | 6776476 | 6880914 | 7086709 | 6783217 | 7147791 | 6929352 |
| 7144095 | 6820974 | 6918647 | 6984016 | 7192125 | 6824251 | 6834939 |
| 6840600 | 6786573 | 7144519 | 6799835 | 6959975 | 6959974 | 7021740 |
| 6935718 | 6938983 | 6938991 | 7226145 | 7140719 | 6988788 | 7022250 |
| 6929350 | 7011393 | 7004566 | 7175097 | 6948799 | 7143944 | 7310157 |
| 7029100 | 6957811 | 7073724 | 7055933 | 7077490 | 7055940 | 10/991402 |
| 7234645 | 7032999 | 7066576 | 7229150 | 7086728 | 7246879 | 7284825 |
| 7140718 | 7284817 | 7144098 | 7044577 | 7284824 | 7284827 | 7189334 |
| 7055935 | 7152860 | 11/203188 | 11/203173 | 11/202343 | 7213989 | 11/225156 |
| 11/225173 | 7300141 | 7114868 | 7168796 | 7159967 | 11/272425 | 7152805 |
| 11/298530 | 11/330061 | 7133799 | 11/330054 | 11/329284 | 7152956 | 7128399 |
| 7147305 | 7287702 | 11/442160 | 7246884 | 7152960 | 11/442125 | 11/454901 |
| 11/442134 | 11/450441 | 11/474274 | 11/499741 | 7270399 | 6857728 | 6857729 |
| 6857730 | 6989292 | 7126216 | 6977189 | 6982189 | 7173332 | 7026176 |
| 6979599 | 6812062 | 6886751 | 10/804057 | 10/804036 | 7001793 | 6866369 |
| 6946743 | 10/804048 | 6886918 | 7059720 | 7306305 | 10/846562 | 10/846647 |
| 10/846649 | 10/846627 | 6951390 | 6981765 | 6789881 | 6802592 | 7029097 |
| 6799836 | 7048352 | 7182267 | 7025279 | 6857571 | 6817539 | 6830198 |
| 6992791 | 7038809 | 6980323 | 7148992 | 7139091 | 6947173 | 7101034 |
| 6969144 | 6942319 | 6827427 | 6984021 | 6984022 | 6869167 | 6918542 |
| 7007852 | 6899420 | 6918665 | 6997625 | 6988840 | 6984080 | 6845978 |
| 6848687 | 6840512 | 6863365 | 7204582 | 6921150 | 7128396 | 6913347 |
| 7008819 | 6935736 | 6991317 | 7284836 | 7055947 | 7093928 | 7100834 |
| 7270396 | 7187086 | 7290856 | 7032825 | 7086721 | 7159968 | 7010456 |
| 7147307 | 7111925 | 11/144812 | 7229154 | 11/505849 | 11/520570 | 11/520575 |
| 11/546437 | 11/540575 | 11/583937 | 7278711 | 7290720 | 11/592207 | 11/635489 |
| 11/604319 | 11/635490 | 11/635525 | 7287706 | 11/706366 | 11/706310 | 11/706308 |
| 11/785108 | 11/744214 | 11744218 | 11748485 | 11/748490 | 11/764778 | 11/766025 |
| 11/834635 | 11839541 | 11860420 | 11/865693 | 11/863118 | 11/866307 | 11/866340 |
| 11/869684 | 11/869722 | 11/869694 | 11/876592 | 11/945244 | 11951121 | 11/945238 |
| 11955358 | 11965710 | 11962050 | | | | |

### BACKGROUND OF THE INVENTION

The Applicant has developed a wide range of printers that employ pagewidth printheads instead of traditional reciprocating printhead designs. Pagewidth designs increase print speeds as the printhead does not traverse back and forth across the page to deposit a line of an image. The pagewidth printhead simply deposits the ink on the media as it moves past at high speeds. Such printheads have made it possible to perform full colour 1600 dpi printing at speeds in the vicinity of 60 pages per minute; speeds previously unattainable with conventional inkjet printers.

Printing at these speeds consumes ink quickly and this gives rise to problems with supplying the printhead with enough ink. Not only are the flow rates higher but distributing the ink along the entire length of a pagewidth printhead is more complex than feeding ink to a relatively small reciprocating printhead.

The high print speeds require a large ink supply flow rate. This mass of ink is moving relatively quickly through the supply line. Abruptly ending a print job, or simply at the end of a printed page, means that this relatively high volume of ink that is flowing relatively quickly must also come to an immediate stop. However, suddenly arresting the ink momentum gives rise to a pressure pulse in the ink line. The components making up the printhead are typically stiff and provide almost no flex as the column of ink in the line is brought to rest. Without any compliance in the ink line, the pressure spike can exceed the Laplace pressure (the pressure provided by the surface tension of the ink at the nozzles openings to retain ink in the nozzle chambers) and flood the front surface of the printhead nozzles. If the nozzles flood, ink may not eject and artifacts appear in the printing.

Resonant standing waves in the ink occur when the nozzle firing pattern matches a resonant frequency of the ink supply line. Again, because of the stiff structures that define the ink line, a large proportion of nozzles for one color, firing simultaneously, can create a standing wave in the ink line. For example, printing spaced black lines for, say, a table of data, will fire many, if not most, of the black nozzles at a particular frequency. If this particular frequency matches a resonant frequency of the ink supply structure, a standing wave can start oscillating back and forth. This can result in nozzle flooding, or conversely nozzle deprime because of the sudden pressure drop after the spike, if the Laplace pressure is exceeded.

The Applicant has addressed these issues by incorporating non-priming cavities into the printhead. A detailed description of the non-priming cavities is provided in the Applicant's co-pending U.S. Ser. No. 11/688,863 (Our Docket No. RRE001US), the contents of which is incorporated herein by reference. Briefly, the stiff structures that define the ink line have air pockets distributed long the length of the printhead. A pressure pulse from a resonant standing wave in the ink will compress the air in the cavity as it passes that point in the ink line. Compressing the air in the cavity damps and dissipates the pressure pulse. The reduced pulse amplitude is less likely to flood the nozzles.

Unfortunately, the lowest resonant frequencies of the ink line have the highest pressure amplitudes. To damp these pressure waves, the non-priming cavities need to be impractically large. A series of large air pockets positioned along the ink line is counter to compact design. Furthermore, diurnal heating and cooling of big air cavities would either pump a large volume of ink out through the nozzles, or deprime the nozzles by drawing ink back into the support molding.

### SUMMARY OF THE INVENTION

Accordingly, the present invention provides a printhead for an inkjet printer, the printhead comprising:

at least one printhead integrated circuit (IC) with an array of nozzles for ejecting ink;

a support structure for supporting the printhead IC, the support structure having an ink conduit for supplying the array of nozzles with ink, the conduit having a set of resonant frequencies at which ink in the conduit generates a standing wave in response to certain operating modes of the array of nozzles; and,
a fluidic damper having a selected resonant frequency that damps the standing waves associated with each of the set of resonant frequencies such that they have an amplitude less than a maximum threshold.

The invention recognizes that particular resonant frequencies are more problematic than others. Typically, the lowest frequency harmonic causes an oscillating pulse with the highest amplitude. However, tuning the fluidic damper precisely to the frequency of the lowest harmonic changes the amplitude of the standing waves at the other frequencies and the next lowest harmonic can then be a problem. Tuning the damper to resonate at a frequency between the two lowest resonant frequencies can sufficiently damp the pressure amplitudes at all the resonant frequencies. The fluid damper uses a single thin tube of ink acting against a compliant structure such as an air cavity. The tube of ink and the air cavity are far more compact than a line of large air cavities along the length of the printhead. Similarly, expansion and contraction of the single small air cavity due to diurnal temperature changes are not problematic.

Preferably, the selected resonant frequency of the fluidic damper is between the two lowest resonant frequencies in the set of resonant frequencies. In a further preferred form, the selected resonant frequency is the root mean square of the two lowest resonant frequencies in the set of resonant frequencies—that is, the square root of the product of the lowest two frequencies.

Preferably, the fluidic damper has a cavity of compressible fluid connected to the ink conduit via a tube configured to at least partially prime with ink when the printhead primes. In a further preferred form, the compressible fluid is air trapped when the printhead is primed with ink. In particular embodiments, the printhead is a pagewidth printhead for printing on A4-sized media, the ink line having a main channel extending longitudinally along the length of the printhead between the inlet and the outlet, the ink line also having a series of non-priming air cavities positioned along its length.

In specific embodiments, the support structure has an inlet for connecting the ink line to an ink supply, and an outlet for connecting the ink line to a waste ink reservoir, the fluidic damper being connected to the ink line adjacent the outlet. Preferably, the fluidic damper has less than 0.4 ml of air.

Optionally, the maximum threshold pressure is less than 4 kPa. Optionally, the ink pressure at the array of nozzles is maintained above −3 kPa to avoid deprime and keep ejected drop volumes above a minimum volume.

In a particularly preferred form, the printhead is configured to print different colored inks, each ink color having a respective fluidic damper, the fluidic damper for one color having a resonant frequency that differs from at least one of the other colors.

### BRIEF DESCRIPTION OF THE DRAWINGS

Preferred embodiments of the invention will now be described by way of example only, with reference to the accompanying drawings, in which:

FIG. 1 is a schematic representation of a prior art printer's fluidic system;

FIGS. 2A, 2B and 2C show the standing waves for the lowest three resonant modes of the printhead ink supply line shown in FIG. 1;

FIG. 3A shows the peak pressures in the ink as a function of frequency for the ink line without a fluidic damper;

FIG. 3B shows the peak pressures in the ink as a function of frequency for the ink line with a fluidic damper tuned to resonate at the first resonant frequency of the ink line;

FIG. 3C shows the peak pressures in the ink as a function of frequency for the ink line with a fluidic damper tuned to resonate at root mean square of the two lowest resonant frequencies of the ink line;

FIG. 4 is a schematic representation of the printhead assembly with fluidic damper according to the present invention;

FIG. 5 shows the printhead cartridge of the present invention installed the print engine of a printer;

FIG. 6 shows the printhead cartridge of the present invention removed from the print engine of a printer;

FIG. 7 is a perspective of the complete printhead cartridge according to the present invention;

FIG. 8 shows the printhead cartridge of FIG. 7 with the protective cover removed;

FIG. 9 is an exploded is a partial perspective of the printhead assembly within the printhead cartridge of FIG. 7;

FIG. 10 is an exploded perspective of the LCP moldings within the printhead cartridge of FIG. 7; and,

FIGS. 11A, 11B and 11C show the outlet manifold of the printhead cartridge.

### DETAILED DESCRIPTION OF THE PREFERRED EMBODIMENTS

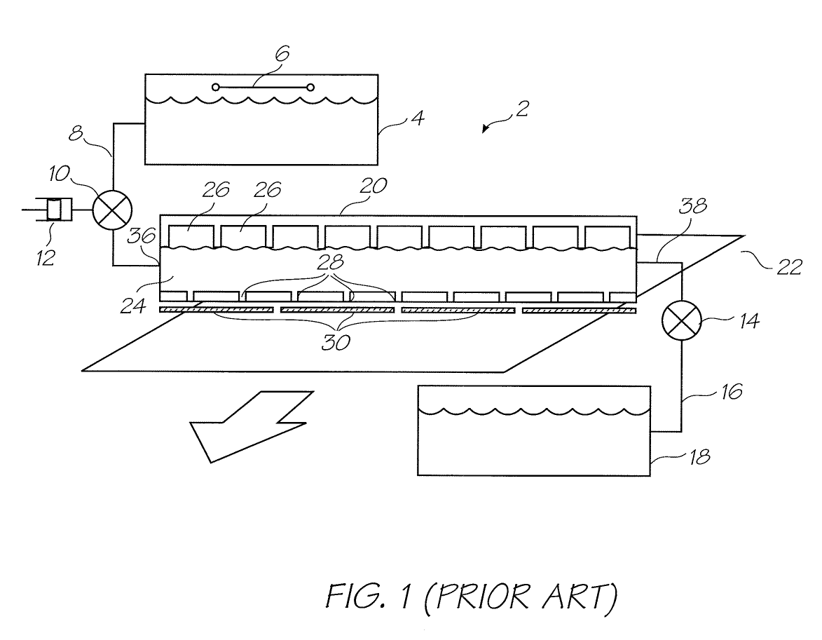

FIG. 1 is a schematic view of a prior art fluidic system of the type used in the above referenced U.S. Ser. No. 11/688,863 (Our Docket No. RRE001US). The operation of the system and its individual components are described in detail in U.S. Ser. No. 11/872,719 (Our Docket No. SBF009US), the contents of which are incorporated herein by reference.

Briefly, the printer fluidic system has a printhead assembly 2 supplied with ink from an ink tank 4 via an upstream ink line 8 and waste ink is drained to a sump 18 via a downstream ink line 16. A single ink line is shown for simplicity. In reality, the printhead has multiple ink lines for full colour printing. The upstream ink line 8 has a shut off valve 10 for selectively isolating the printhead assembly 2 from the pump 12 and or the ink tank 4. The pump 12 is used to actively prime or flood the printhead assembly 2. The pump 12 is also used to establish a negative pressure in the ink tank 4. During printing, the negative pressure is maintained by the bubble point regulator 6.

The printhead assembly 2 is an LCP (liquid crystal polymer) molding 20 supporting a series of printhead ICs 30 secured with an adhesive die attach film (not shown). The printhead ICs 30 have an array of ink ejection nozzles for ejecting drops of ink onto the passing media substrate 22. The nozzles are MEMS (micro electromechanical) structures printing at true 1600 dpi resolution (that is, a nozzle pitch of 1600 npi), or greater. The fabrication and structure of suitable printhead IC's 30 are described in detail in U.S. Ser. No. 11/246687 (Our Docket No. MNN001US) the contents of which are incorporated by reference. The LCP molding 20 has a main channel 24 extending between the inlet 36 and the outlet 38. The main channel 24 feeds a series of fine channels 28 extending to the underside of the LCP molding 20. The fine channels 28 supply ink to the printhead ICs 30 through laser ablated holes in the die attach film.

Above the main channel 24 is a series of non-priming air cavities 26. These cavities 26 are designed to trap a pocket of air during printhead priming. The air pockets give the system some compliance to absorb and damp pressure spikes or hydraulic shocks in the ink. The printers are high speed pagewidth printers with a large number of nozzles firing rapidly. This consumes ink at a fast rate and suddenly ending a print job, or even just the end of a page, means that a column of ink moving towards (and through) the printhead assembly 2 must be brought to rest almost instantaneously. Without the compliance provided by the air cavities 26, the momentum of the ink would flood the nozzles in the printhead ICs 30. Furthermore, the subsequent ‘reflected wave’ can generate a negative pressure strong enough to deprime the nozzles.

In the majority of cases, the air cavities 26 offer sufficient damping. However, the printhead can operate in modes that excite the ink to one of the resonant frequencies of the ink line. For example, printing black lines across a page at a particular spacing (for a table, bar code or the like) requires all the black nozzles to fire simultaneously for brief periods. This cyclic input to the ink line can quickly establish a standing wave oscillating at a resonant frequency. The peak to peak pressures of these standing waves can overwhelm the damping provided by the air cavities 26 and flood or deprime the nozzles. The volume of the air cavities would need to be greatly increased in order to accommodate the peak pressures of the standing waves.

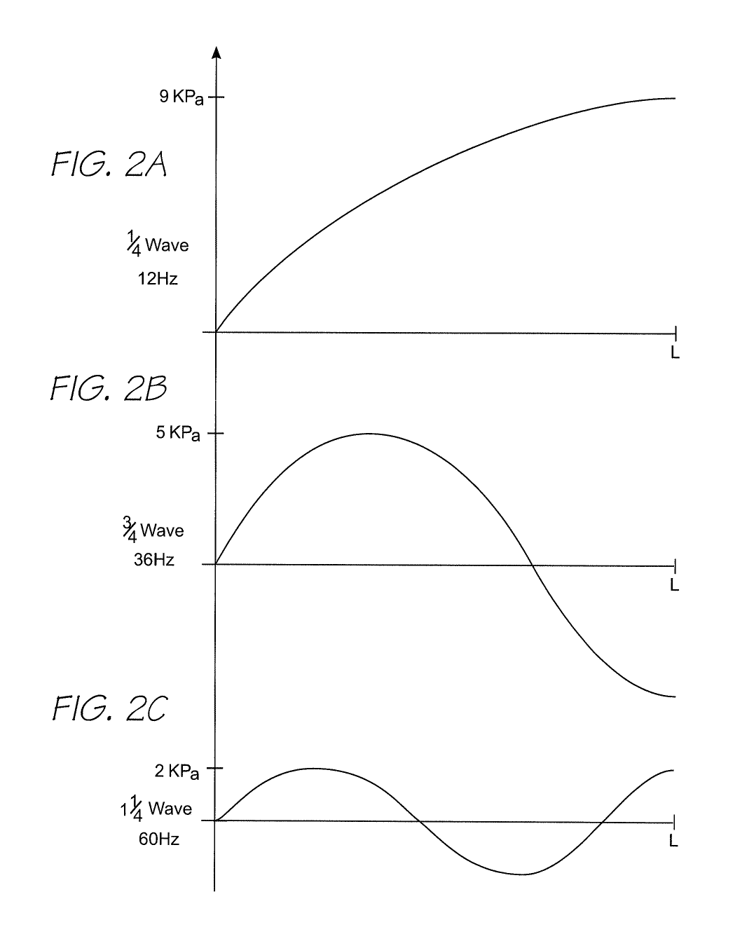

FIGS. 2A, 2B and 2C, show the three lowest harmonics for printhead assembly shown in FIG. 1. It should be noted that the main channel responds as if it is a blind end even though it has the outlet 38. Because it is a closed end, the main channel resonates with a quarter wave harmonic, a three quarter wave harmonic, a 1.25 wave harmonic and so on. An open end would resonate at 0.5 wave, full wave, 1.5 wave and so on. The lowest harmonics have the highest amplitude standing waves and therefore, are the most problematic. If these harmonics occur at frequencies at which the printhead can operate, there is the potential for pressure pulses above the flooding threshold and below the deprime threshold. Nozzle flooding or deprime occurs when the ink pressure exceeds the Laplace pressure of the ink meniscus across the nozzle aperture. Obviously, this will depend on nozzle geometry (as well as other factors such as operating temperature).

FIG. 2A is the lowest frequency harmonic; the quarter wave, in which the length L of the LCP main channel is one quarter the wavelength. Testing on some of the Applicant's A4 printers has shown this to occur at about 12 Hz and has a peak amplitude of about 9 kPa. The next harmonic is the 0.75 wave shown in FIG. 2B. It has a lower amplitude (approx. 5 kPa) and occurs at 36 Hz. Finally, the 1.25 wave is shown in FIG. 2C which has an amplitude of about 2 kPa at 60 Hz. As the frequency of the harmonic increases, the amplitude of the wave rapidly attenuates. Hence the higher frequency harmonics have peak pressures small enough for the non-priming air cavities to damp.

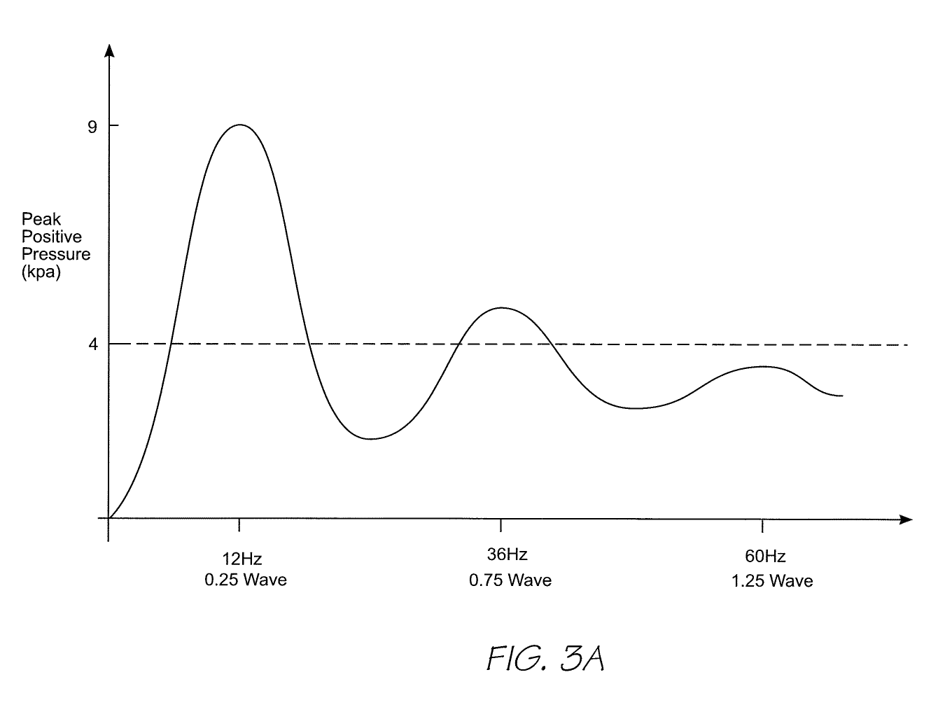

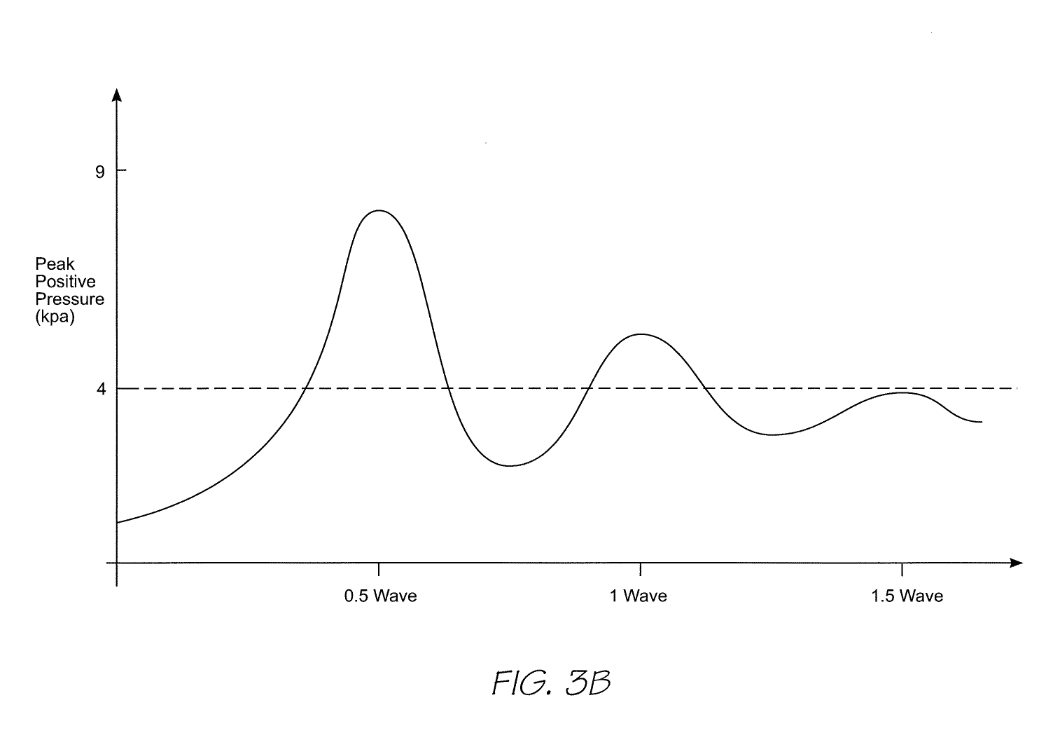

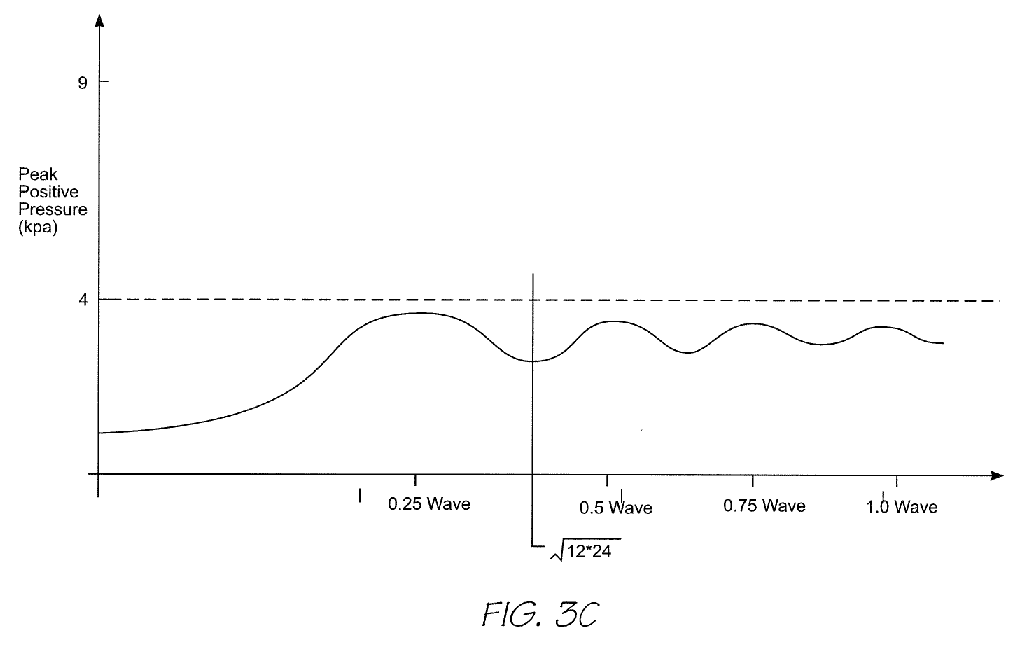

FIG. 3A shows these pressure peaks as function of frequency. If the deprime and flood thresholds are set at, say, −3 kPa and 4 kPa respectively, it can be seen that the quarter wave and three quarter wave harmonics have peak pressures that will be problematic for printer operation. However, incorporating a damper that resonates at the quarter wave frequency does not solve the problem. FIG. 3B shows the change in the frequency response curves when a fluidic damper tuned to the quarter wave is added to the end of the main channel 24 (see FIG. 1). Essentially the main channel now responds as if it were an open channel and the half wave, full wave etc harmonics become relevant. One or more of these harmonics may also generate excessive peak pressures.

FIG. 3C shows the frequency response when the fluidic damper is tuned to a frequency between the quarter and half wave harmonics. This attenuates both the quarter and half wave harmonics. The Applicant has found that the optimum resonant frequency for the fluidic damper is approximately the root mean square of the quarter wave frequency and the half wave frequency; that is, the square root of the product of the quarter wave resonant frequency and the half wave resonant frequency. In reality, it is necessary to test several frequencies around the root mean square frequency to find to the optimum resonant frequency for the fluidic damper. Irregularities such as ink filters, bends and elasticity in the ink supply line and so on shift the actual pressure response curves from the theoretical curves.

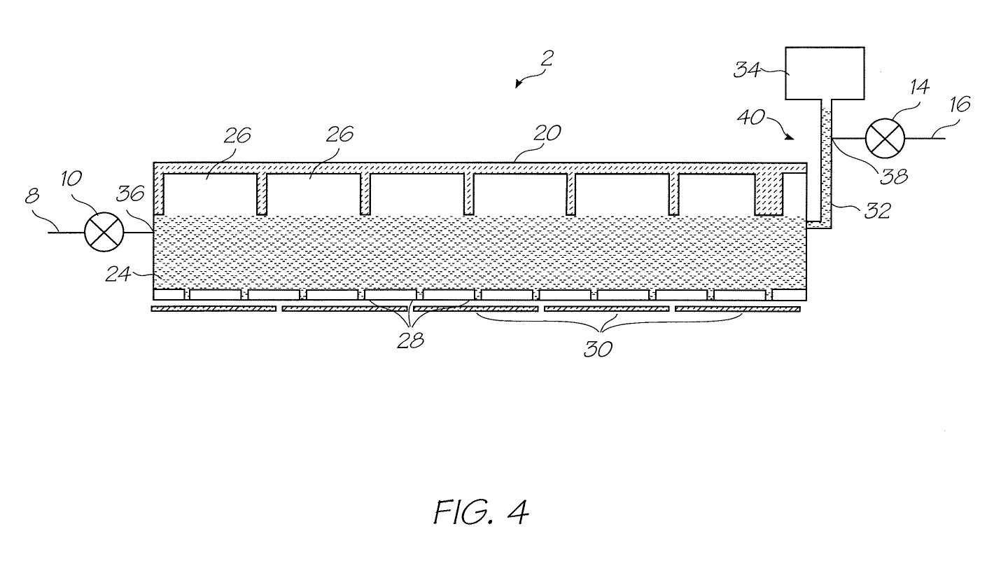

FIG. 4 is a schematic representation of the printhead assembly 2 according to the present invention. The LCP molding 20 has a fluidic damper 40 that resonates at a frequency selected to attenuate potentially problematic standing waves at any of the resonant frequencies of the main channel 24. The fluidic damper 40 has a thin tube 32 filled with ink connecting the main channel 24 to a small cavity of compressible fluid 34—most typically air. The thin tube of ink has an inertance proportional to its length, cross sectional area and density of the ink. The air cavity is a compliance against which the ink in the thin tube 32 can oscillate.

In the printhead assembly shown, the fluidic damper is tuned to a frequency at or near the root mean square of the quarter wave and the half wave resonant frequency of the main channel 24 in the LCP molding 20. As discussed above, the impedance provided by the damper at the quarter and half wave harmonics is sufficient to keep both of them less than the predetermined pressure threshold. Positioning the fluidic damper 40 adjacent the outlet 38 of the main channel 24 is most effective as it transmits the majority of the standing wave and the reflected wave is small.

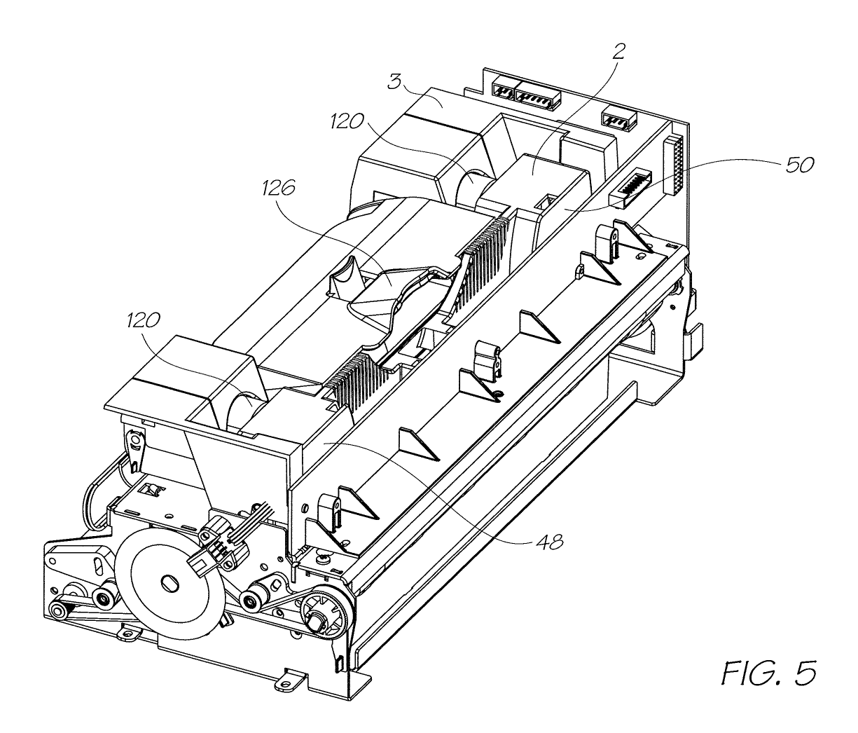

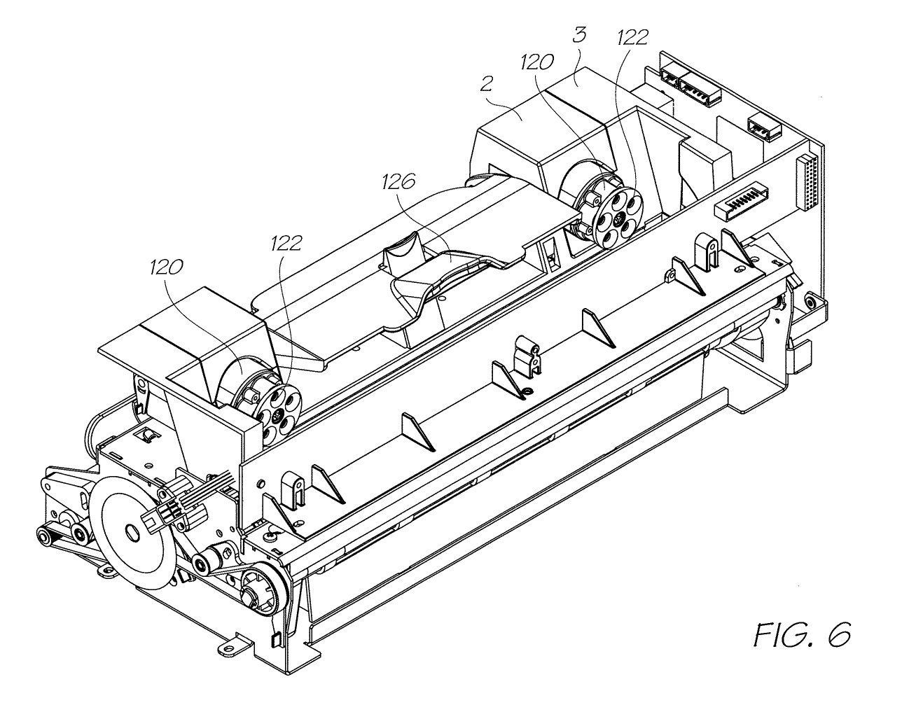

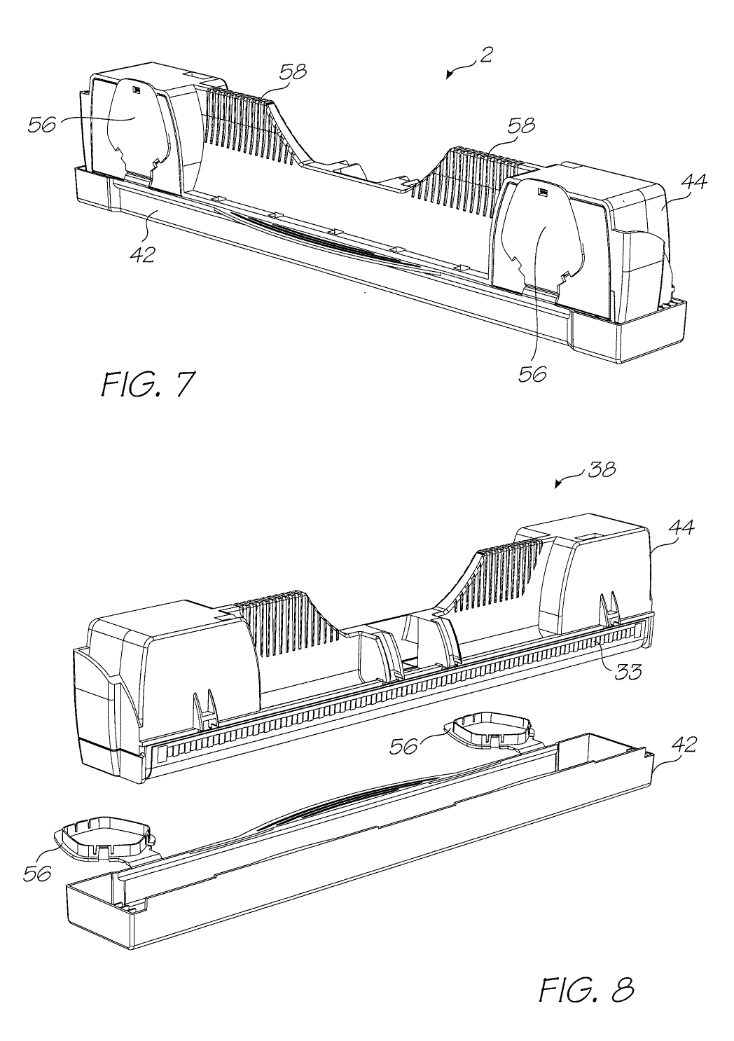

The invention will now be described with reference to the Applicant's printhead cartridge and print engine shown in FIGS. 5 and 6. A printhead cartridge recognizes that individual ink ejection nozzles may fail over time and eventually there are enough dead nozzles to cause artifacts in the printed image. Allowing the user to replace the printhead maintains the print quality without requiring the entire printer to be replaced. The print engine 3 is the mechanical heart of a printer which can have many different external casing shapes, ink tank locations and capacities, as well as different media feed and collection trays.

FIG. 5 shows a printhead cartridge 2 installed in a print engine 3. The printhead cartridge 2 is inserted and removed by the user lifting and lowering the latch 126. The print engine 3 forms an electrical connection with contacts on the printhead cartridge 2 and fluid couplings 120 are formed at the inlet and outlet manifolds, 48 and 50 respectively.

FIG. 6 shows the print engine 3 with the printhead cartridge removed to reveal the apertures 122 in the fluid couplings 120. The apertures 122 engage spouts on the inlet and outlet manifolds (48 and 50 of FIG. 5). The fluid couplings 120 connect the inlet manifold to an ink tank, and the outlet manifold to a sump. As discussed above, the ink tanks, media feed and collection trays have an arbitrary position and configuration relative to the print engine 3 depending on the design of the printer's outer casing.

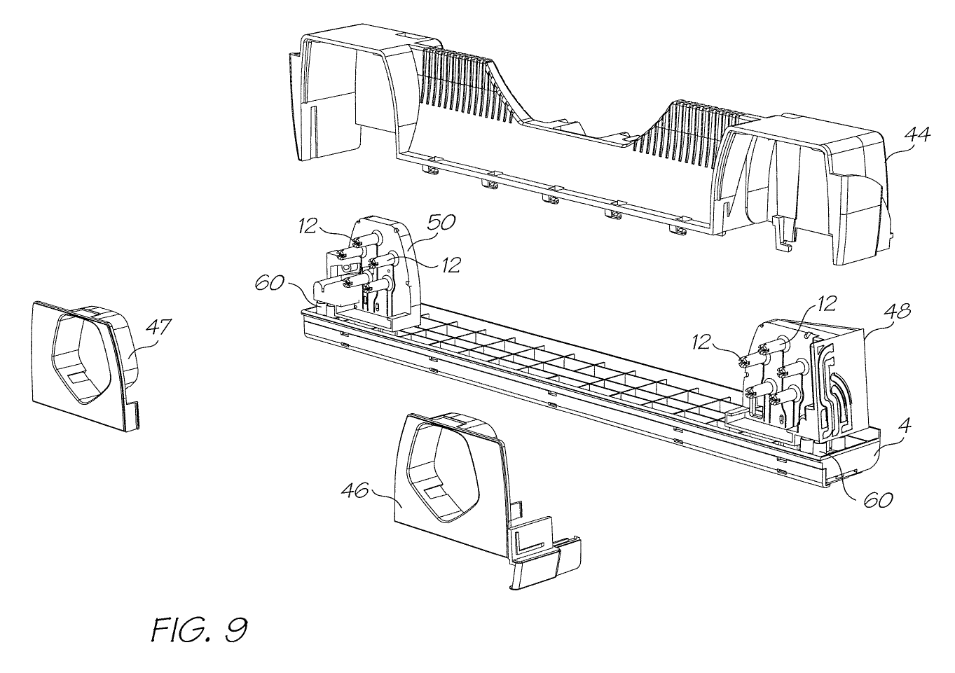

FIG. 7 shows the printhead assembly 2 as a printhead cartridge for user insertion and removal from the printer body (see FIG. 6). The printhead cartridge 2 has a top molding 44 and a removable protective cover 42. The top molding 44 has a central web for structural stiffness and to provide textured grip surfaces 58 for manipulating the cartridge during insertion and removal. The base portion of the protective cover 42 protects the printhead ICs (not shown) and line of contacts (not shown) prior to installation in the printer. Caps 56 are integrally formed with the base portion and cover the ink inlets and outlets (see 54 and 52 of FIG. 9).

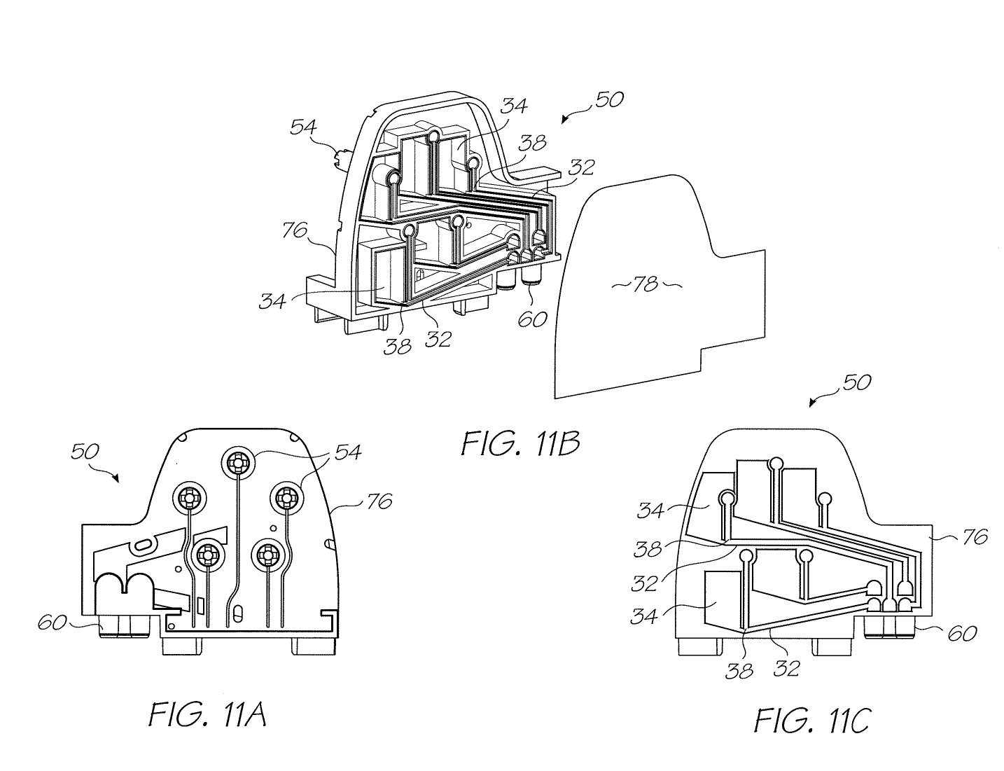

FIG. 8 shows the printhead assembly 2 with its protective cover 42 removed to expose the printhead ICs on the bottom surface and the line of contacts 33 on the side surface. The protective cover is discarded to the recycling waste or fitted to the printhead cartridge being replaced to contain leakage from residual ink. FIG. 9 is a partially exploded perspective of the printhead assembly 2. The top cover 44 has been removed reveal the inlet manifold 48 and the outlet manifold 50. The inlet and outlet shrouds 46 and 47 have been removed to better expose the five inlet and outlet conduits, 52 and 54 respectively. The inlet and outlet manifolds 48 and 50 form a fluid connection between each of the individual inlets and outlets and the corresponding main channel 24 (see FIG. 11) in the LCP molding 20. As discussed above, the main channels extend beneath the line of non-priming air cavities 26.

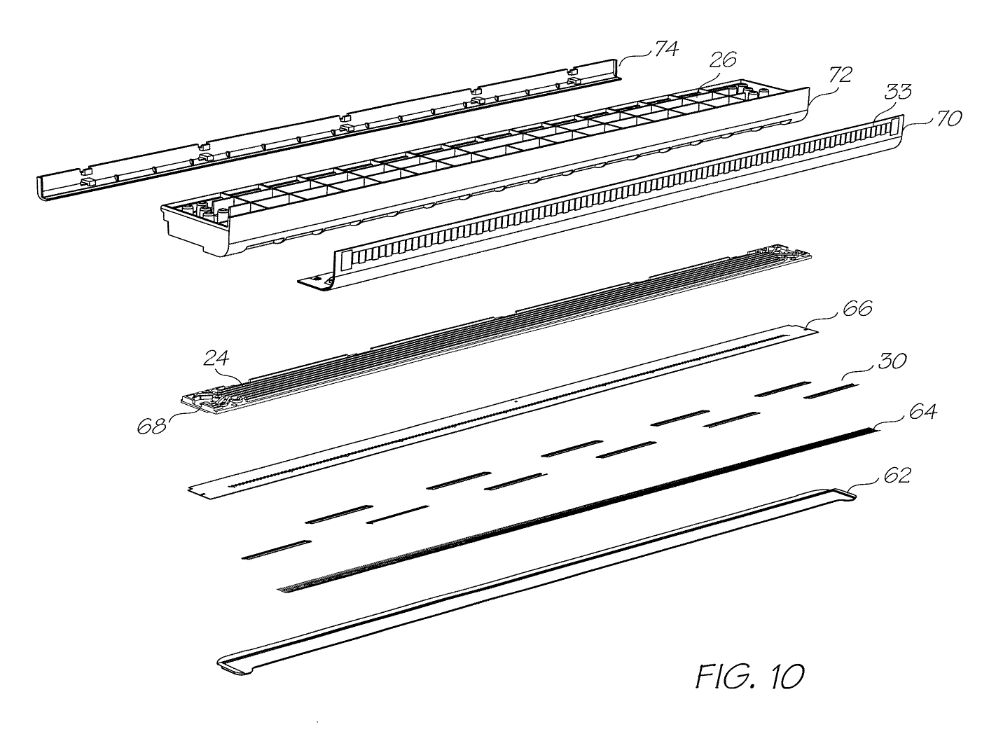

FIG. 10 is an exploded perspective of the printhead assembly without the inlet or outlet manifolds or the top cover molding. The main channels 24 for each ink color and their associated air cavities 26 are formed in the channel molding 68 and the cavity molding 72. Adhered to the bottom of the channel molding 68 is a die attach film 66. As discussed above in relation to FIG. 1, the die attach film 66 mounts the printhead ICs 30 to the channel molding such that the fine channels on the underside of the are in fluid communication with the printhead ICs 30 via small laser ablated holes through the film.

Flex PCB 70 is adhered to the side of the air cavity molding 72 and wraps around to the underside of the channel molding 68. The printer controller connects to the lines of contacts 33. At the other side of the flex PCB 70 is a line of wire bonds 64 to electrically connect the conductors in the flex 70 to each of the printhead ICs 30. The wire bonds 64 are covered in encapsulant 62 which is profiled to have a predominantly flat outer surface. On the other side of the air cavity molding 72 is a paper guide 74 to direct sheets of media substrate past the printhead ICs at a predetermined spacing.

FIGS. 11A, 1B and 1C show the outlet manifold 50 detached from the rest of the printhead cartridge. Interface plate 76 has outlet spouts 54 for connection to the ink sump housed in the printer body. The coupling 60 connects to each of the main channels 24 in the channel molding 68 (see FIG. 10). As shown in FIGS. 11B and 11C, the inner side of the interface plate 76 supports the thin inks tubes 32 and the air cavities 34 for the respective main channels. The ink line outlets 38 connect to the thin tubes 32 immediately before the air cavities 34. The air cavities 34 and the thin tubes 32 are sealed from each other with the heat sealable foil 78 applied to the back of the outlet manifold 50. The foil 78 is heat sealed around the entire perimeter of the five air cavities and ink tubes as it is essential that they are completely sealed from each other. To ensure the seal is not compromised during use, the heat seal resists internal pressure to 100 kPa.

When the printhead assembly primes, the ink flows through the thin tube 32 as far the outlet 38 only. The length of the ink column in the thin tube, the diameter of the tube and the properties of the ink determine an inertance for the ink in the tube. The inertance is equates to the dash-pot in the equivalent mechanical damper and the inductor in an electrical damper. The volume of the air cavity is relatively small; less than 0.4 ml, and typically between 0.15 ml and 0.3 ml. This provides to the spring in a mechanical damper or the capacitor in the corresponding electrical circuit.

As the main channels 24 of the channel molding 68 have slightly different configurations, the resonant frequencies are likewise different. Accordingly, the fluidic dampers for each main channel 24 are tuned to resonate at different frequencies for optimum damping of each ink line.

The invention has been described herein by way of example only. Skilled workers in this field will readily recognize many variations and modifications that do not depart from the spirit and scope of the broad inventive concept.

1. A printhead for an inkjet printer, the printhead comprising:
at least one printhead integrated circuit (IC) with an array of nozzles for ejecting ink;
a support structure for supporting the printhead IC, the support structure having an ink conduit for supplying the array of nozzles with ink, the conduit having a set of resonant frequencies at which ink in the conduit generates a standing wave in response to certain operating modes of the array of nozzles; and,
a fluidic damper having a selected resonant frequency that damps the standing waves associated with each of the set of resonant frequencies such that they have an amplitude less than a maximum threshold.

2. A printhead according to claim 1 wherein the selected resonant frequency of the fluidic damper is between the two lowest resonant frequencies in the set of resonant frequencies.

3. A printhead according to claim 2 wherein the selected resonant frequency is the square root of the product of the two lowest resonant frequencies.

4. A printhead according to claim 1 wherein the fluidic damper has a cavity of compressible fluid connected to the ink conduit via a tube configured to at least partially prime with ink when the printhead primes.

5. A printhead according to claim 4 wherein the compressible fluid is air trapped when the printhead is primed with ink.

6. A printhead according to claim 1 wherein the printhead is a pagewidth printhead for printing on A4-sized media, the ink line having a main channel extending longitudinally along the length of the printhead between the inlet and the outlet, the ink line also having a series of non-priming air cavities positioned along its length.

7. A printhead according to claim 1 wherein the support structure has an inlet for connecting the ink line to an ink supply, and an outlet for connecting the ink line to a waste ink reservoir, the fluidic damper being connected to the ink line adjacent the outlet.

8. A printhead according to claim 4 wherein the cavity of compressible fluid in the fluidic damper has less than 0.4 ml of air.

9. A printhead according to claim 1 wherein the maximum threshold pressure is less than 4 kPa.

10. A printhead according to claim 9 wherein the ink pressure at the array of nozzles is maintained above −3 kPa to avoid deprime and keep ejected drop volumes above a minimum volume.

11. A printhead according to claim 1 wherein the printhead is configured to print different colored inks, each ink color having a respective fluidic damper, the fluidic damper for one color having a resonant frequency that differs from at least one of the other colors.
